(19) United States
(12) Patent Application Publication
(10) Pub. No.: US 2023/0085572 A1
(43) Pub. Date: Mar. 16, 2023

(54) OPTICAL FIBER MANAGEMENT TRAYS AND ASSEMBLIES WITH FEATURES FOR IMPROVED ROLLABLE FIBER RIBBON ROUTING

(71) Applicant: COMMSCOPE CONNECTIVITY BELGIUM BV, Kessel-Lo (BE)

(72) Inventors: Roel Modest Willy BRYON, Aarschot (BE); Mohamed AZNAG, Scherpenheuvel-Zichem (BE); Olivier ROCHE, Schaerbeek (BE); Mirza KASUMOVIC, Leuven (BE)

(73) Assignee: COMMSCOPE CONNECTIVITY BELGIUM BV, Kessel-Lo (BE)

(21) Appl. No.: 17/800,828

(22) PCT Filed: Feb. 17, 2021
(86) PCT No.: PCT/EP2021/053892

§ 371 Date: Aug. 18, 2022

Related U.S. Application Data
(60) Provisional application No. 62/978,040, filed on Feb. 18, 2020.

(51) Int. Cl. G02B 6/44

(52) U.S. Cl. CPC G02B 6/4454

(57) ABSTRACT

An optical fiber management tray, such as a splice tray, and related assemblies. The tray includes fiber guiding features for improved routing of reliable ribbon fiber on the tray. In some embodiments, a fiber management tray is configured to receive a routed fiber ribbon and a plurality of routed individual optical fibers, the tray being further configured to support a plurality of individual fiber splices that splice the fibers of the ribbon fiber to the individual fibers.

### CROSS-REFERENCE TO RELATED APPLICATION

This application claims the benefit of U.S. Patent Application Ser. No. 62/978,040, filed on Feb. 18, 2020, the disclosure of which is incorporated herein by reference in its entirety.

### BACKGROUND

Fiber optic cables carry optical fibers used to transmit optical signals between providers and subscribers. Typically, large cables, such as trunk cables or “main” cables, carry a large number of fibers. The fibers of the main cable are spliced, split, optically connected to other fibers (e.g., via fiber optic connectors), or otherwise managed and routed to a desired destination, (e.g., a subscriber building). Due to the large number of fibers that need to be managed and routed, the main cable is often terminated in a fiber optic splice closure. Such fiber optic splice closures typically include an outer ruggedized and sealable shell defining an interior volume and one or more sealable ports for sealed cable entry to the interior. The closures can be adapted for outdoor or indoor use. The interior volume of a splice closure typically houses structures and equipment, such as splice trays to organize and route fibers to facilitate both storing of fibers and routing of fibers to their desired destinations.

The fibers of the cables that enter the closures can come in different forms, such as loose fibers or ribbonized fibers. Groups of loose fibers, e.g., groups of 12 loose fibers, or axial portions thereof, can be housed in protective tubes. Ribbonized fibers (or a fiber ribbon) include a plurality of fibers, e.g., 12 fibers, bonded together. The fibers of the ribbon can be bonded side by side along their axial lengths to form a flat ribbon, or bonded at intervals along their axial lengths to form a rollable ribbon of fibers or a rollable fiber ribbon. Example rollable fiber ribbons include the AccuRiser™ and AccuFlex® rollable ribbon cables by OFS Fitel, LLC, Norcross, Ga., U.S.A.

Depending on specific signal routing requirements at a given closure, it may be desirable to route fiber ribbons, loose fibers or both. However, different fiber forms have different mechanical characteristics and tendencies that come into play as the fibers are curved or bent to follow a desired routing path.

### SUMMARY

In general terms, the present disclosure is directed to fiber optic closures and optical fiber management assemblies that can be housed in the fiber optic closures.

According to certain aspects, the fiber management assemblies include one or more fiber management trays that include one or more features that enhance routing of rollable fiber ribbons onto the trays.

Rollable fiber ribbons include bonded sections of the fibers interspersed by longitudinal non-bonded sections. Rollable fiber ribbons can include any suitable number of fibers, such as 4, 6, 8, 10, 12 fibers, or more. Due to the non-bonded sections, there is a tendency for individual ones of the fibers in the non-bonded sections to depart or stray from the path or desired path of the overall rollable ribbon, particularly when the path includes curves, which can cause signal transmission reduction, signal loss, and/or fiber breakage.

Aspects of the present disclosure can reduce the incidence or likelihood of individual fibers of a rollable fiber ribbon straying from the overall ribbon path as the rollable ribbon is routed onto a fiber management tray.

In some aspects, the fiber ribbon is routed from a guide channel of a support tower that pivotally supports the tray, and aspects of the present disclosure can reduce the incidence or likelihood of individual fibers of the rollable fiber ribbon straying from the overall ribbon path as the rollable ribbon is routed between the guide channel and the fiber management tray.

Further aspects of the present disclosure relate to routing both individual fibers and a fiber ribbon (e.g., a rollable ribbon or a flat ribbon) onto the same fiber management tray and holding individual fiber splices of the fibers of the ribbon to the individual fibers at a splice holder supported by the tray.

Further aspects of the present disclosure relate to an optical fiber management tray that supports both individual fiber splices and fiber ribbon splices, the fiber ribbons being one or both of flat ribbons and rollable ribbons.

Further aspects of the present disclosure relate to an assembly including a fiber management tray having one or more fiber ribbon routing features and configured to support fiber ribbon splices and having first coupling element that pivotally couples to a complementary second coupling element of a support tower having guide channels for guiding the rollable ribbon from the support tower to the fiber management tray.

In some examples, the second coupling element is also configured to pivotally couple to a different fiber management tray that can support single fiber splices but cannot support fiber ribbon splices.

Further aspects of the present disclosure relate to a fiber optic closure at which fiber optic cables are terminated, and which defines a closure volume that houses fiber management trays and assemblies according to further aspects of the present disclosure.

According to certain aspects of the present disclosure, there is provided a fiber management tray for managing optical fibers, the tray extending from a proximal end to a distal end along a first axis defining a length of the tray, from a first side to a second side along a second axis perpendicular to the first axis, the second axis defining a width of the tray, and from a top to a bottom along a third axis perpendicular to the first and second axes, the third axis defining a height of the tray, the first and second axes defining a reference plane, the tray comprising: a fiber management surface lying parallel to the reference plane; one or more hinge components defining a pivot axis that is parallel to the second axis; walls extending from the fiber management surface parallel to the third axis, the walls and fiber management surface defining a channel, the channel including a channel entryway through which optical fibers exterior to the tray can enter the tray, the channel entryway being defined by the walls and a portion of the fiber management surface connecting the walls; a finger projecting proximally from an exterior side of one of the walls to a free, proximal end of the finger, the finger extending proximally beyond a distal end of the channel entryway, wherein there is a material void between the finger and the entryway.

According to further aspects of the present disclosure, there is provided fiber management tray for managing optical fibers, the tray extending from a proximal end to a distal end along a first axis defining a length of the tray, from a first side to a second side along a second axis perpendicular to the first axis, the second axis defining a width of the tray, and from a top to a bottom along a third axis perpendicular to the first and second axes, the third axis defining a height of the tray, the first and second axes defining a reference plane, the tray comprising: a fiber management surface lying parallel to the reference plane; one or more hinge components defining a pivot axis that is parallel the second axis; walls extending from the fiber management surface parallel to the third axis, the walls and fiber management surface defining a channel, the channel including a channel entryway through which optical fibers exterior to the tray can enter the tray, the channel entryway being defined by the walls and a portion of the fiber management surface connecting the walls; and a finger projecting proximally from an exterior side of one of the walls to a free, proximal end of the finger, the finger extending proximally beyond a distal end of the channel entryway, the finger including a main body and a first prong extending proximally from the main body, wherein the finger including a second prong extending proximally from the main body, the first and second prongs being spaced apart from each other parallel to the second axis with a material void therebetween, the first and second prongs each defining a notch.

A variety of additional aspects will be set forth in the description that follows. The aspects relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The following drawings are illustrative of particular embodiments of the present disclosure and therefore do not limit the scope of the present disclosure. The drawings are not necessarily to scale and are intended for use in conjunction with the explanations in the following detailed description. Embodiments of the present disclosure will hereinafter be described in conjunction with the appended drawings, wherein like numerals denote like elements.

FIG. 1 is a partially exploded view of a prior art telecommunications closure.

FIG. 2 is a perspective view of an example assembly of a tower and fiber management trays.

FIG. 3 is a perspective view of the assembly of FIG. 2, including one of the trays, the tray being in a pivoted down position.

FIG. 4 is a perspective view of the assembly of FIG. 3, the tray being in a pivoted up position.

FIG. 5 is a perspective view of the tray of the assembly of FIG. 3.

FIG. 6 is a further perspective view of the tray of the assembly of FIG. 3.

FIG. 7 is a top planar view of a portion of the tray of FIG. 5.

FIG. 8 is a bottom planar view of a portion of the tray of FIG. 5.

FIG. 9 is an enlarged perspective view of a proximal portion of the tray of FIG. 5.

FIG. 10 is a further enlarged perspective view of a proximal portion of the tray of FIG. 5.

FIG. 11 is a perspective view of a portion of the assembly of FIG. 3, the tray being in a pivoted up position.

FIG. 12 is a perspective view of a portion of the assembly of FIG. 3, the tray being in a pivoted down position.

FIG. 13 is a top, planar view of a portion of the assembly of FIG. 3, the tray being in a pivoted down position.

FIG. 14 is a top, perspective view of a portion of the assembly of FIG. 3, the tray being in a pivoted up position.

FIG. 15 illustrates rollable fiber ribbons routed onto a tray of the assembly of FIG. 2, the tray being in a pivoted down position.

FIG. 16 illustrates a portion of the rollable fiber ribbons and assembly of FIG. 15, with the tray being in a pivoted up position.

FIG. 17 is a perspective view of an example assembly of a tower and fiber management trays according to the present disclosure, wherein the assembly can provide one or more advantages over the assembly of FIG. 2.

FIG. 18 is a perspective view of the assembly of FIG. 17, including one of the trays, the tray being in a pivoted down position.

FIG. 19 is a perspective view of the assembly of FIG. 18, the tray being in a pivoted up position.

FIG. 20 is a perspective view of the tray of the assembly of FIG. 18, the tray being configured to support both individual fiber splices and fiber ribbon splices.

FIG. 21 is a further perspective view of the tray of FIG. 20.

FIG. 22 is a top planar view of a proximal portion of the tray of FIG. 20.

FIG. 23 is a bottom planar view of a proximal portion of the tray of FIG. 20.

FIG. 24 is a perspective view of a proximal portion of the tray of FIG. 20.

FIG. 25 is a further perspective view of a proximal portion of the tray of FIG. 20.

FIG. 26 illustrates rollable fiber ribbons routed on a portion of the tray of FIG. 20.

FIG. 27 illustrates rollable fiber ribbons routed onto a tray of the assembly of FIG. 17, the tray being in a pivoted down position.

FIG. 28 illustrates a portion of the rollable fiber ribbons and assembly of FIG. 27, with the tray being in a pivoted up position.

FIG. 29 is a further perspective view of the assembly of FIG. 18, the tray being in a pivoted down position.

FIG. 30 is a further perspective view of the assembly of FIG. 18, the tray being in a pivoted up position.

FIG. 31 is a perspective view of a portion of the assembly of FIG. 18, the tray being in a pivoted down position.

FIG. 32 is a perspective view of a portion of the assembly of FIG. 18, the tray being in a pivoted up position.

FIG. 33 is a top view of a portion of the assembly of FIG. 18, the tray being in a pivoted down position.

FIG. 34 is a top, perspective view of the assembly of FIG. 18, the tray being in a pivoted up position.

FIG. 35 is a perspective view of a further example assembly of a tower and fiber management trays according to the present disclosure, wherein the assembly can provide one or more advantages over the assembly of FIG. 2.

FIG. 36 is a perspective view of the assembly of FIG. 35, including one of the trays, the tray being in a pivoted down position.

FIG. 37 is a perspective view of the assembly of FIG. 36, the tray being in a pivoted up position.

FIG. 38 is a perspective view of the tray of the assembly of FIG. 36, the tray being configured to support both individual fiber splices and fiber ribbon splices.

FIG. 39 is a further perspective view of the tray of FIG. 38.

FIG. 40 is a top planar view of a proximal portion of the tray of FIG. 38.

FIG. 41 is a bottom planar view of a proximal portion of the tray of FIG. 38.

FIG. 42 is a perspective view of a proximal portion of the tray of FIG. 38.

FIG. 43 is a further perspective view of a proximal portion of the tray of FIG. 38.

FIG. 44 is a further perspective view of the assembly of FIG. 36, the tray being in a pivoted down position.

FIG. 45 is a further perspective view of the assembly of FIG. 36, the tray being in a pivoted up position.

FIG. 46 is a perspective view of a portion of the assembly of FIG. 36, the tray being in a pivoted down position.

FIG. 47 is a perspective view of a portion of the assembly of FIG. 36, the tray being in a pivoted up position.

FIG. 48 is a top view of the portion of the assembly of FIG. 36, the tray being in a pivoted down position.

FIG. 49 is a top, perspective view of the assembly of FIG. 36, the tray being in a pivoted up position.

FIG. 50 shows an assembly similar to the assembly of FIG. 17 mounted to an organizer assembly of a telecommunications closure, and showing rollable fiber ribbons routed between the tower and the fiber management trays.

FIG. 51 is a perspective view of a further embodiment of a fiber management tray according to the present disclosure.

FIG. 52 is a further perspective view of the tray of FIG. 51.

FIG. 53 is a perspective view of a further embodiment of a fiber management tray according to the present disclosure.

FIG. 54 is a further perspective view of the tray of FIG. 53.

FIG. 55 is a view of the tray of FIG. 51 showing an example routing configuration of schematically illustrated rollable fiber ribbons on the tray.

FIG. 56 is a view of the tray of FIG. 53 showing an example routing configuration of schematically illustrated rollable fiber ribbons on the tray.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

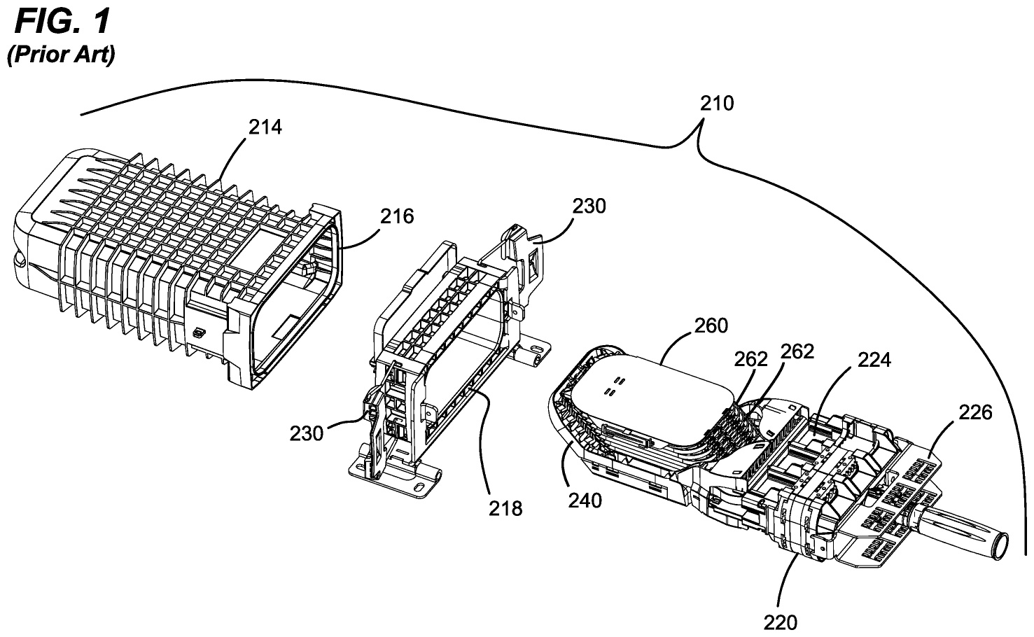

Referring to FIG. 1, a prior art telecommunications closure assembly 210 includes a cover 214 having an open end 216. A base 218 mounts to the cover 14 with latches 230 and a seal, making the closure both sealable and re-enterable. The cover and the base are thus interfacing housing pieces of the closure. A seal block 220 seals to the base 218 to thereby seal the interior of the closure assembly 210. Cables enter and exit through the seal block 220 and are managed by the organizer 260. The seal block also includes cable fixation areas 224, 226. The organizer 260 can include various functions including slack storage, splicing, and splitting of fiber optic cables.

A tower 240 mounts to an end of the cable organizer 260 and defines pivotal mounting locations for mounting pivoting fiber organizing trays 262. Trays 262 pivot upwardly away from the tower 240. Each tray 260 can receive an incoming and outgoing single loose fiber or multiple loose fibers which can be managed by each tray. Managing of optical fibers can include, e.g., managing splices, splitters, wave division multiplexors, storage, etc. Each tray 260 includes cable routing areas and cable splicing areas where splice holders can be mounted to the tray.

The contents of International Patent Application Publication Number WO2013/149846 are hereby fully incorporated by reference in their entirety.

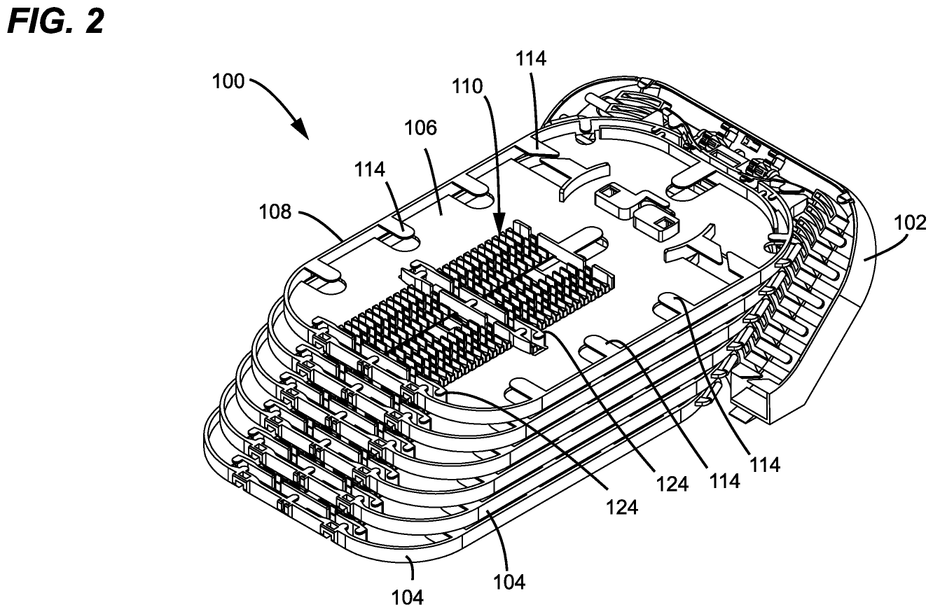

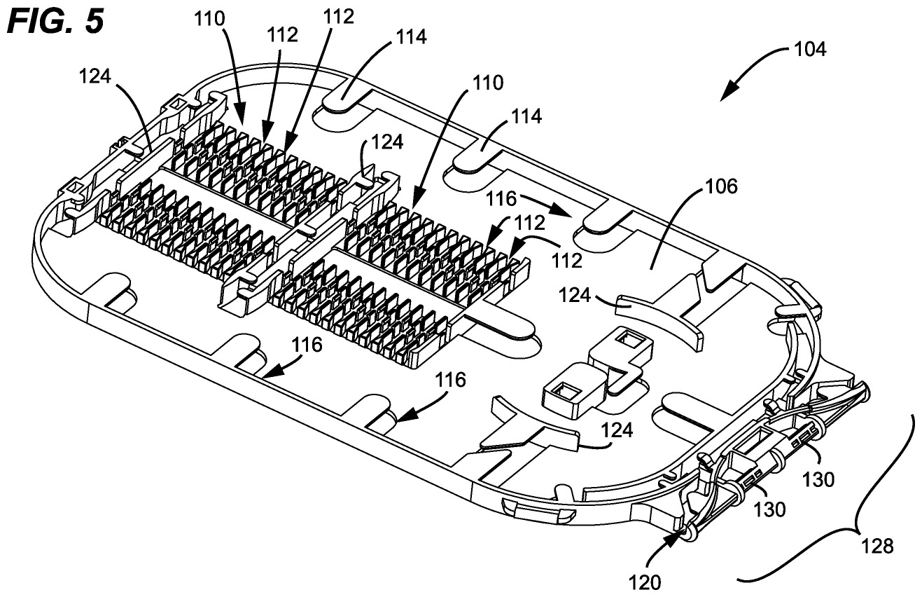

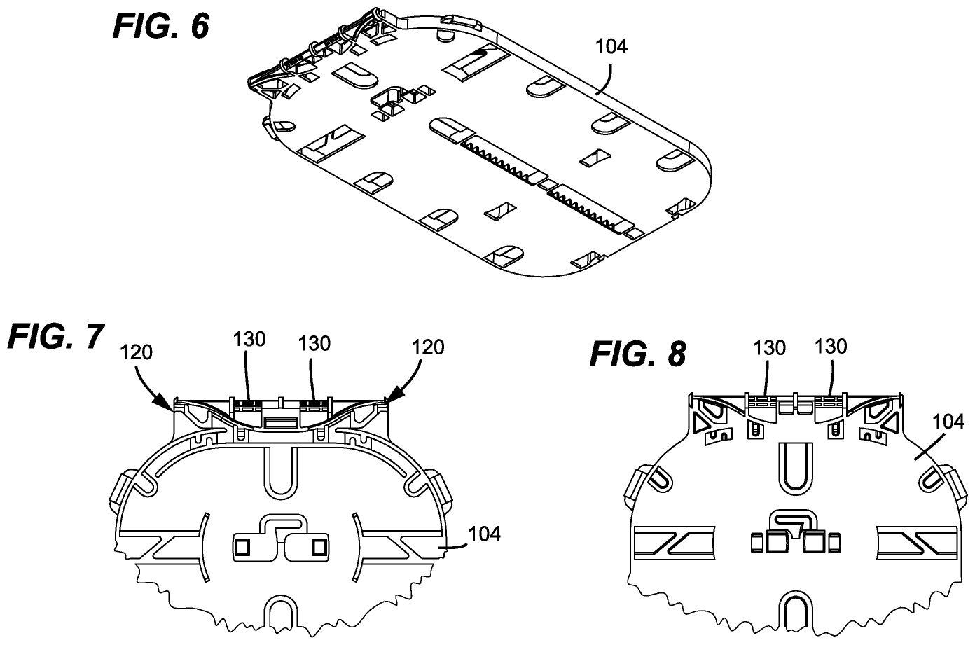

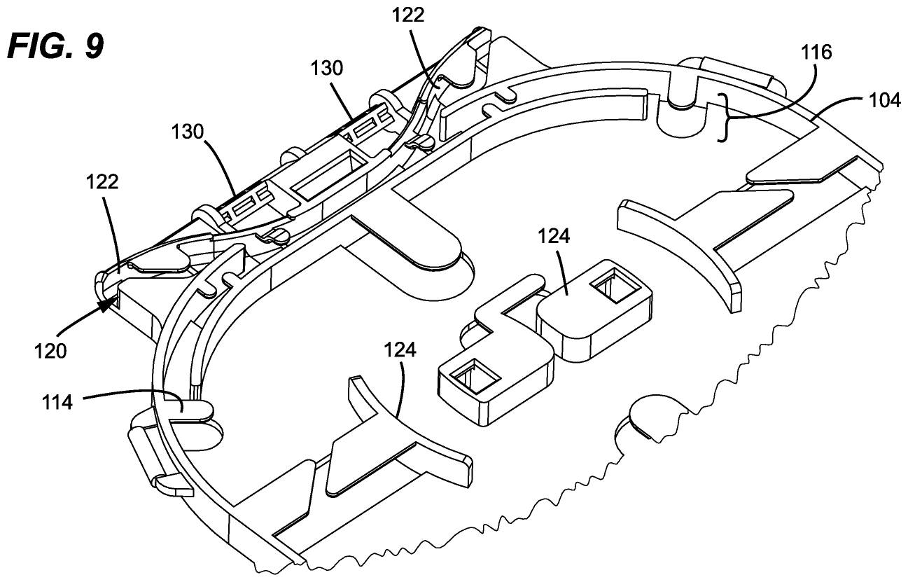

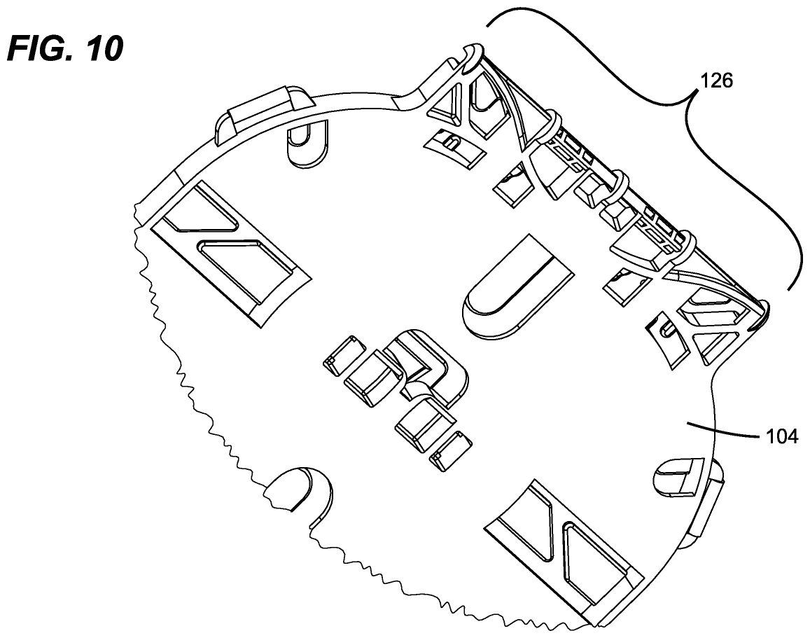

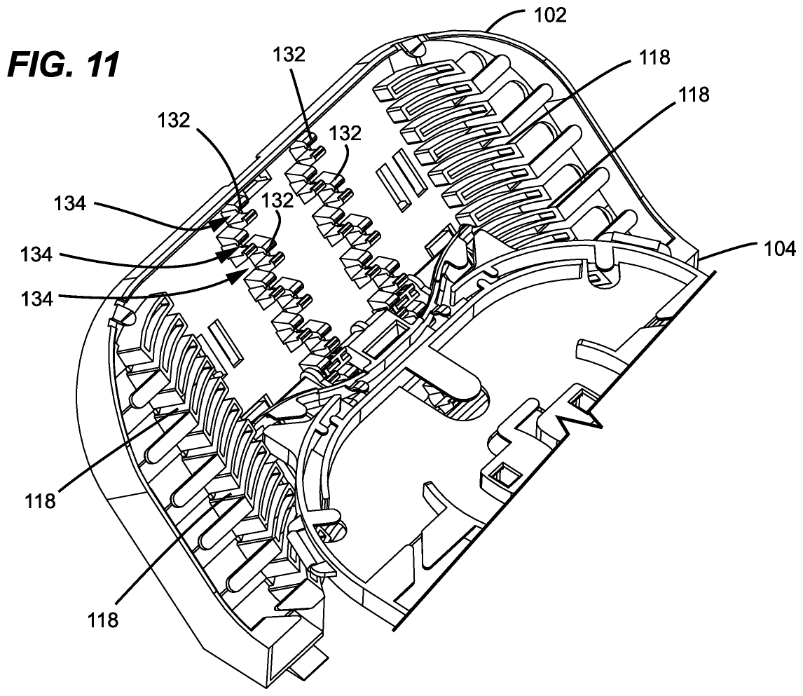

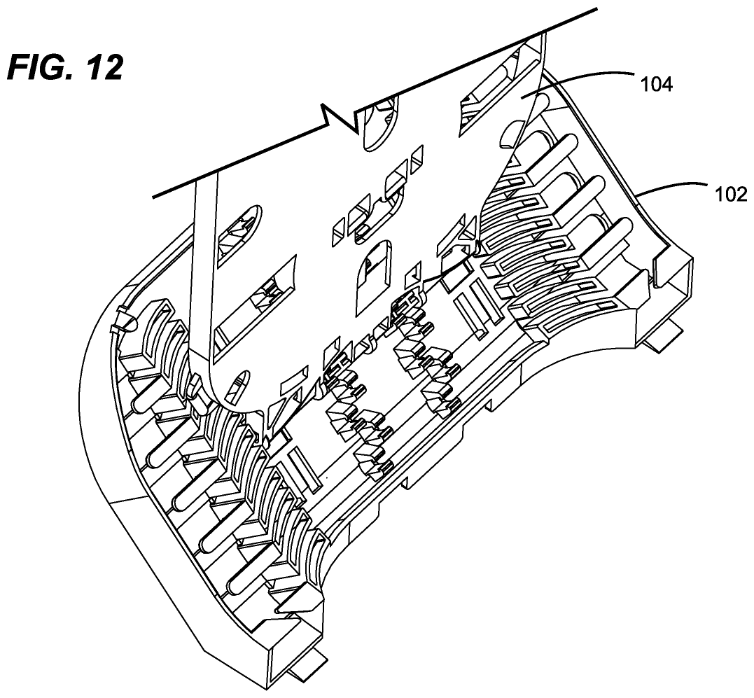

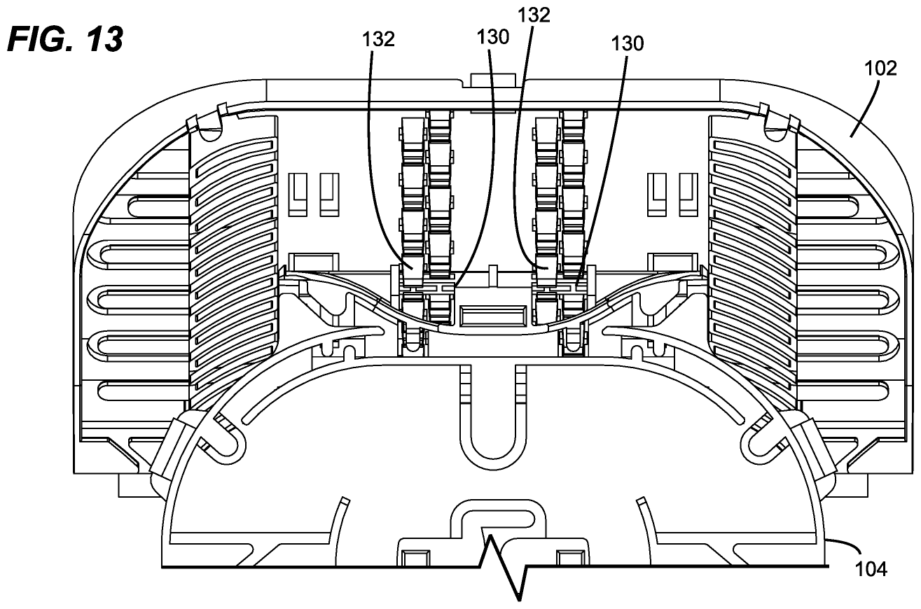

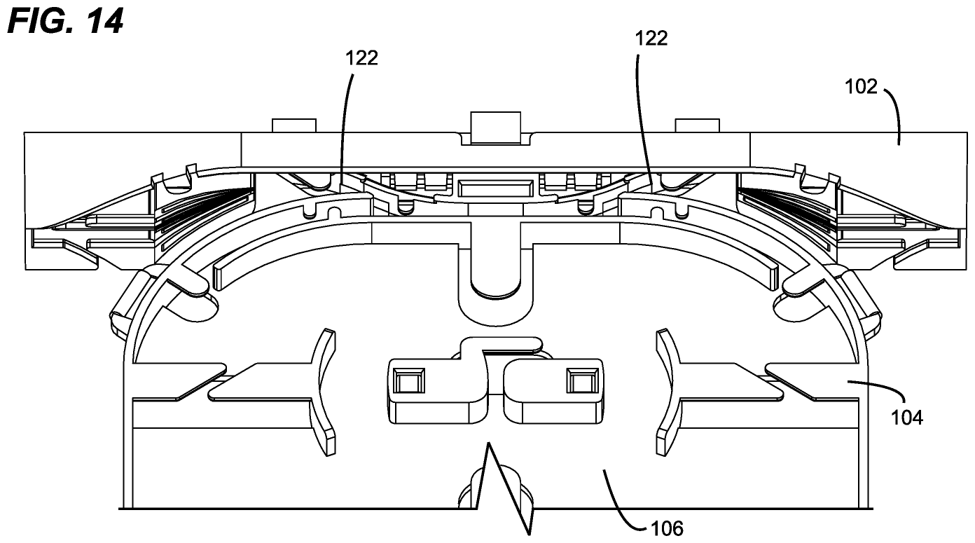

Referring to FIGS. 2-16, an assembly 100 includes a tower 102 to which are pivotally mounted six fiber management trays 104. The assembly 100 can substitute for the tower 240 and trays 262 of the organizer 260 of FIG. 1.

Each tray has a fiber management surface 106 and a peripheral wall 108 that follows an outer perimeter of the fiber management surface 106. Fiber retaining tabs 114 project from the wall 108 defining a space 116 between the retaining tabs 114 and the fiber management surface 106 in which fibers can be routed.

The fiber management surface mounts splice holder blocks (splice holders) 110. Each splice holder block 110 includes a plurality of splice body receivers 112, and each splice body receiver 112 is configured to hold a splice body of a single fiber splice.

Fibers can enter a tray via a tower fiber channel 118 of the tower 102. Typically, such a fiber is routed from a cable (e.g., a feeder cable) entering the closure in which the assembly 100 is to be housed. The jacket of the cable is stripped to expose optical fibers and an unstripped portion of the jacket is fixed at a cable fixation area of the closure. The optical fibers are then guided from the cable to the base of the organizer, from the base of the organizer to the tower, and from a tower fiber channel 118 onto one of the trays 104. The tray supports the fiber's splice to another fiber routed into the closure via another cable (e.g., a drop cable) entering and affixed to the closure.

Loose fibers enter the tray 104 via an entryway 120 to a channel 122 of the tray, which is in communication with the rest of the fiber management surface 106, allowing the fiber to be routed to a splice holder. The tray 104 includes two such entryways 120 and channels 122 at opposite sides allowing for fiber entry onto the tray 104 from both sides of the tray and from the tower fiber channels on both sides of the tray. Typically, one or more loops of a given fiber are stored at the fiber management surface 106, with the tabs 114 and other routing and guiding structures 124 facilitating loops storage within permitted bend radius limitations.

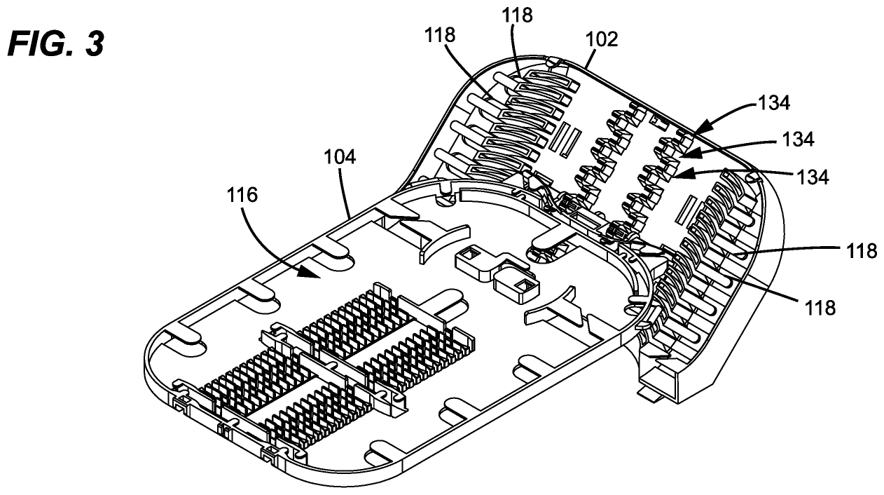

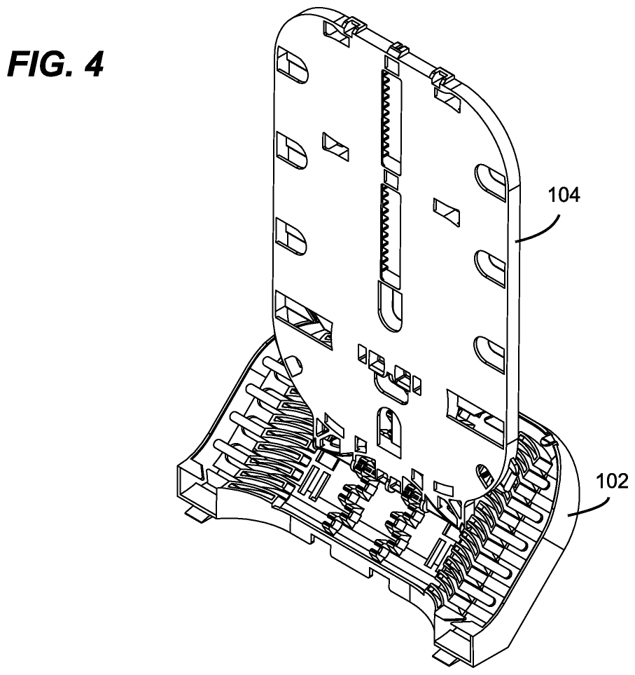

Adjacent the channels 122 is a hinge portion 126 that includes hinge components. The hinge components include square bars 130 that are received in clips 132 of the tower 102. The interfacing of the flat sided bars 130 and the clips 132 allows the tray 104 to frictionally hold in a pivoted up position (FIG. 4) until sufficient torque is applied to overcome the frictional fit between squared bar and clip to return the tray 104 to the pivoted down position (FIG. 3). The clips 132 are hinge components of the tower 102 that are complementary to the hinge components 130 of the trays 140. The hinge components 132 of the tower 102 define a total of twelve hinge locations 134. However, due to the height of the tray wall, which is required to accommodate fiber ribbons at the surface 106, only every other of the twelve hinge locations 134 can be occupied, such that the tower 102 pivotally supports a maximum of six of the trays 104 mounted at every other one of hinge locations 134. Pivoting of one of the trays permits access to the fiber management surface of the tray below it.

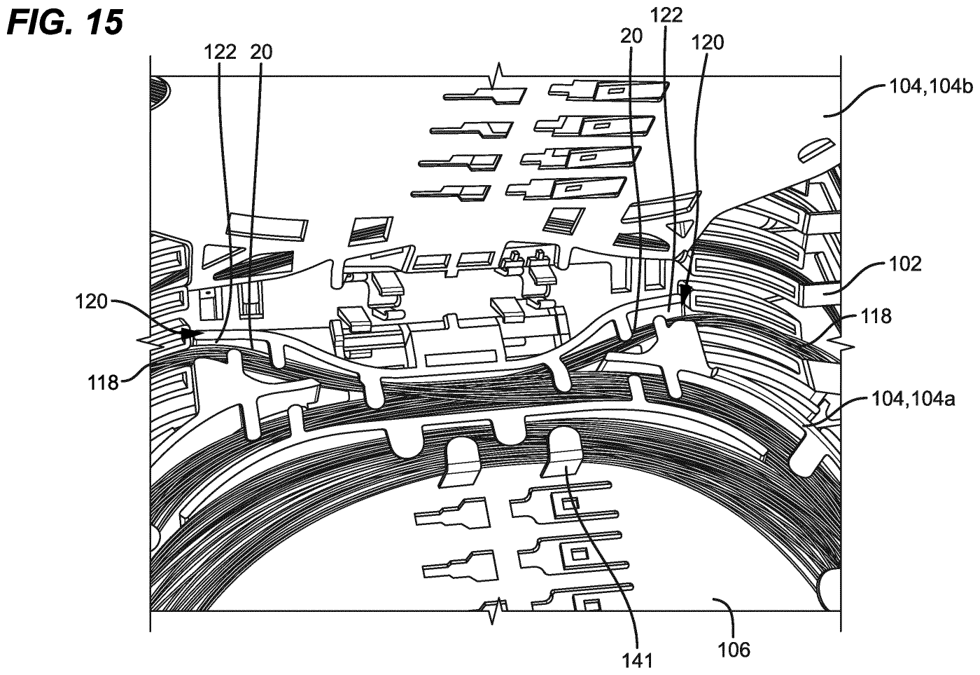

Referring to FIGS. 15-16, a ribbon fiber guide module 141 is mounted to the fiber management surface 106. The structures of the channels 122 and entryways 120 in FIGS. 15-16 are identical to the corresponding features in FIGS. 2-14. In FIG. 15, the tray 104a is in the pivoted down position and the tray 104b above it is in the pivoted up position.

Referring to FIG. 16, the tray 104a is in the pivoted up position. As shown in the callout area 150, individual fibers 22 of the rollable ribbon 20 have strayed from the desired routing path directly from the tower fiber channel 118 through the entryway 120. This straying can be caused by the bundling and intermittent bonding of the individual fibers 22 in the rollable ribbon, resulting in path deviations of individual fibers as the bundle is pivoted or twisted, as is the case when pivoting to the pivoted up position. The straying of the fibers 22 can cause pinching between structures (such as between the tray and the tower as shown), and/or overbending of the stray fibers, which phenomena can cause breakage of the fibers and/or signal loss or signal degradation. The configuration of the channels 118 and 122, and particularly of the channel 122 in proximity to the channel 118, causes restriction in the freedom of movement of the individual fibers of the rollable ribbon as the ribbon is rotated or twisted, causing the unwanted fiber deviation from the desired routing path.

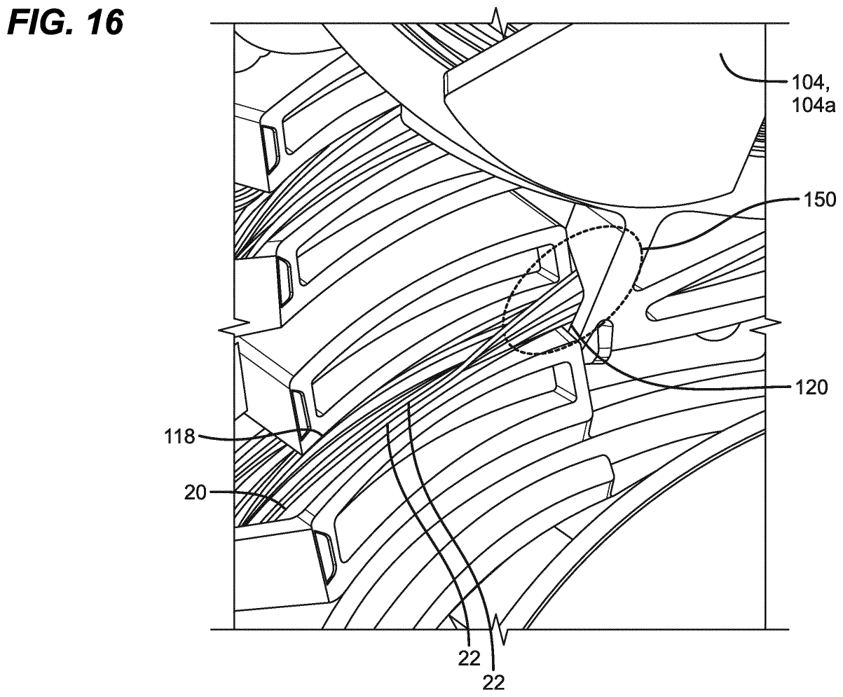

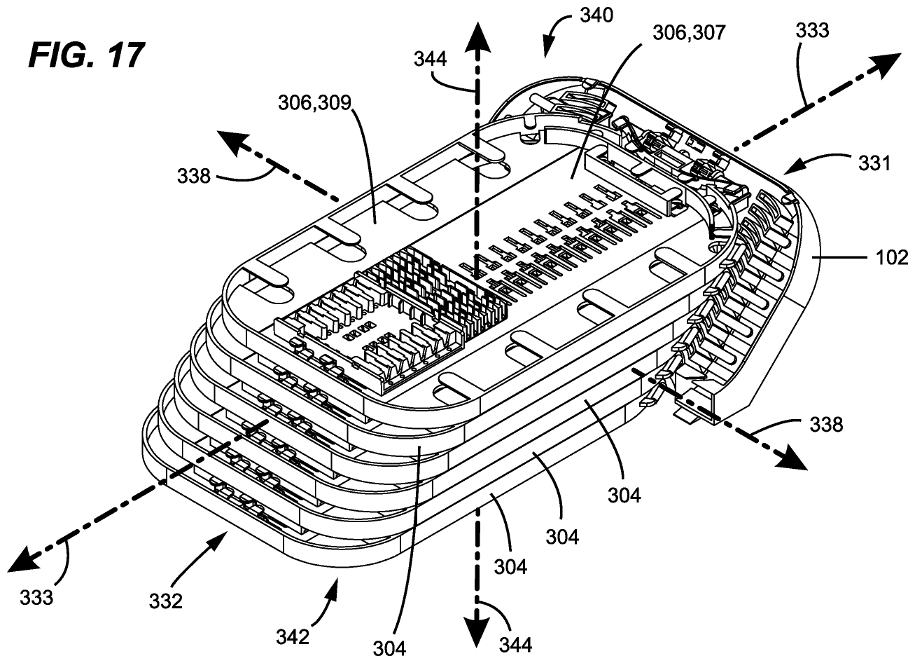

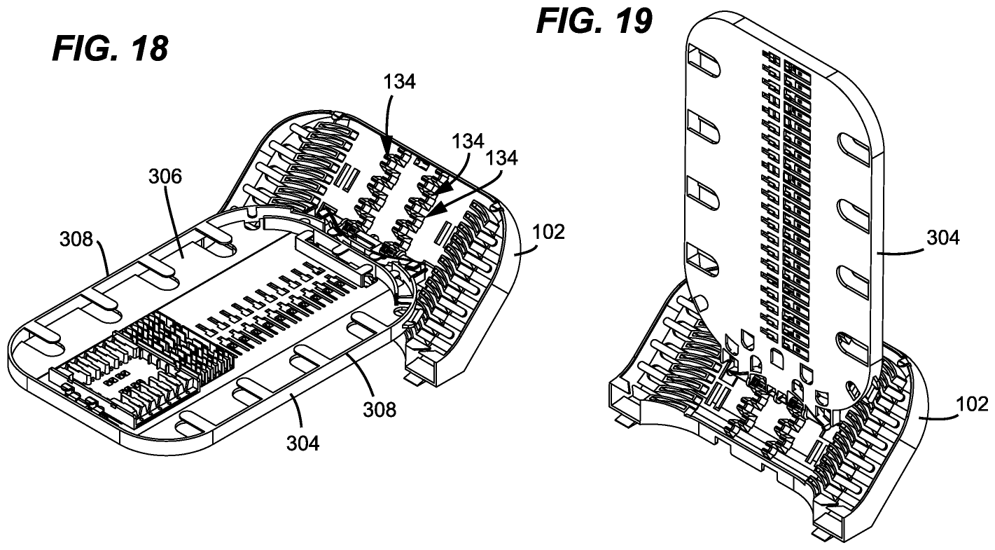

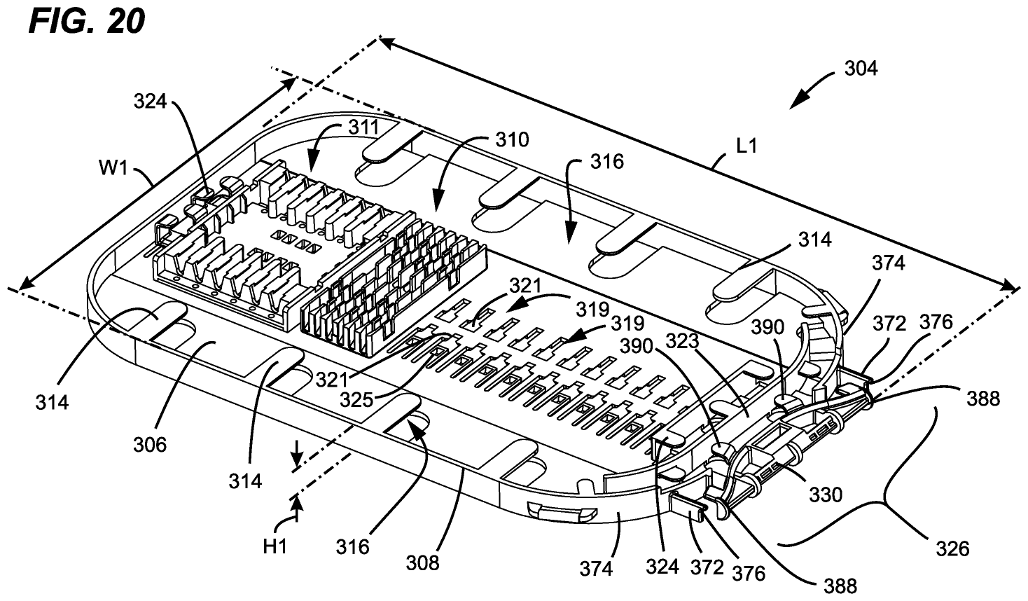

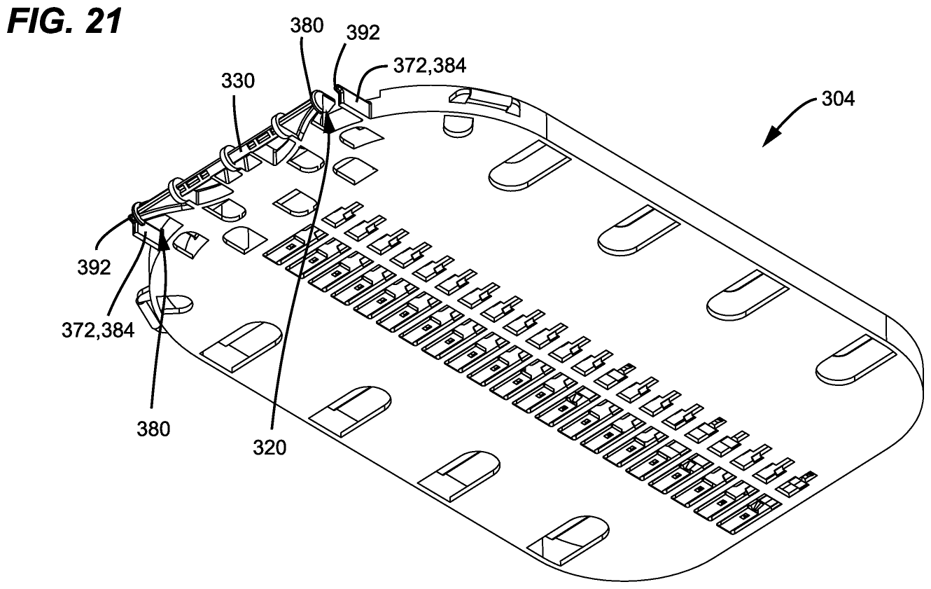

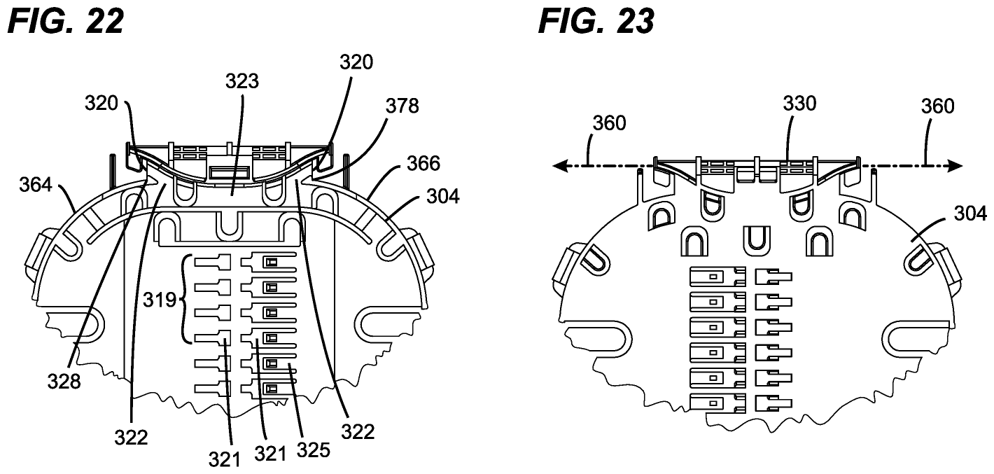

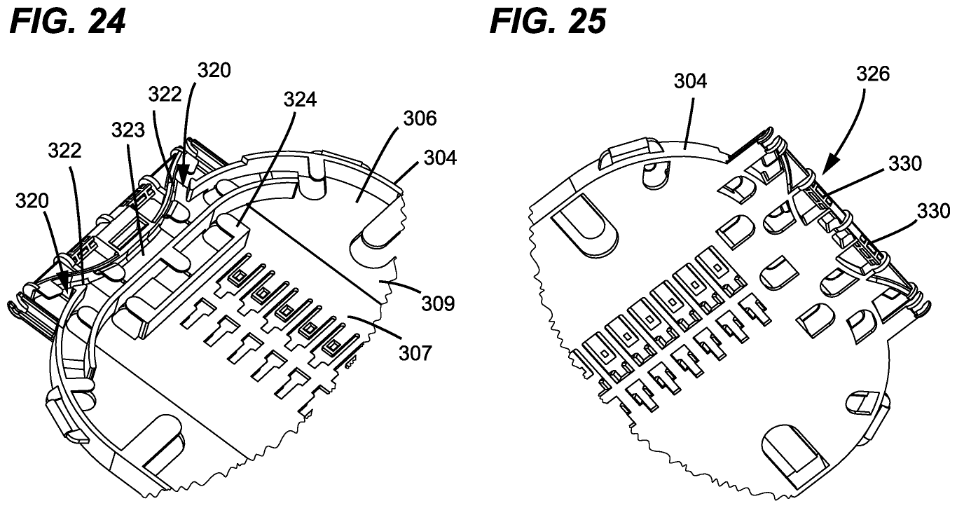

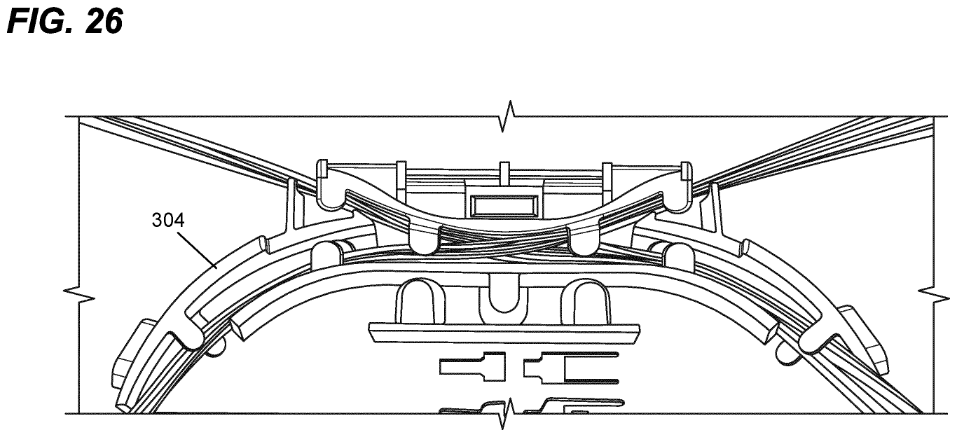

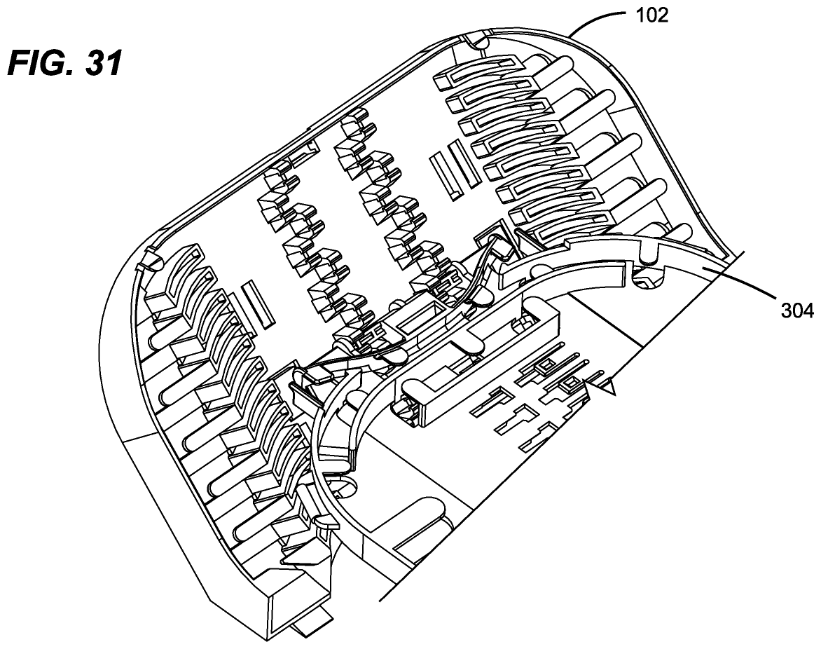

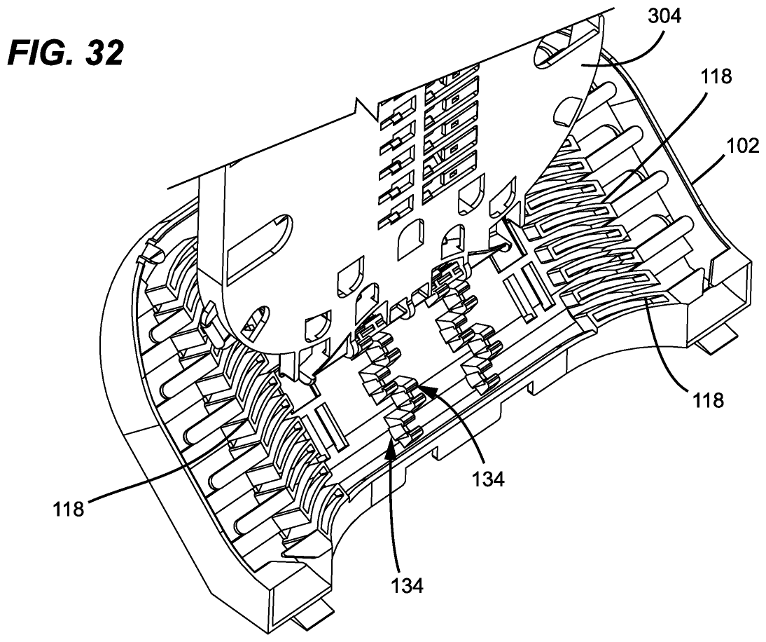

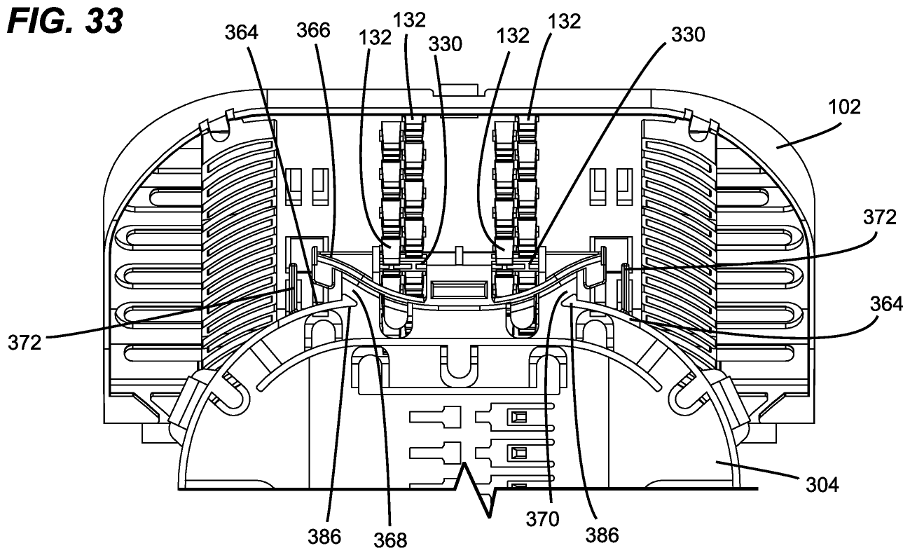

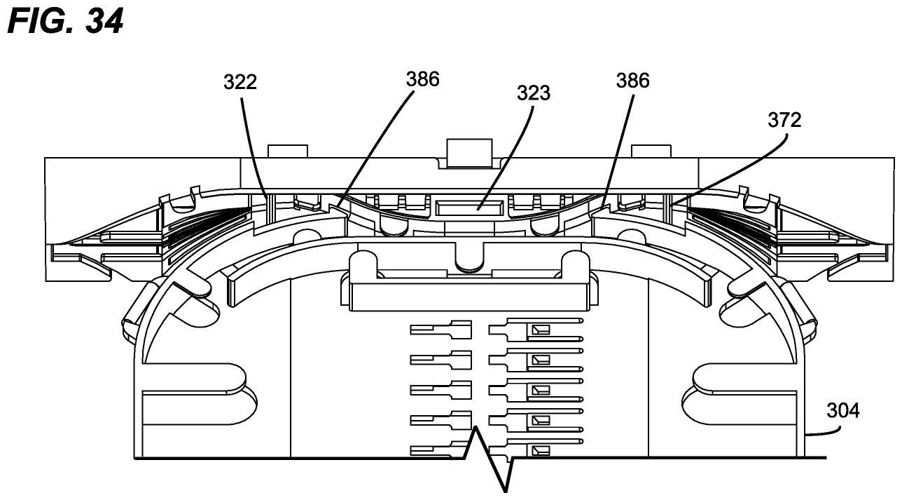

Referring to FIGS. 17-34, an assembly 300 having the same tower 102 described above and trays 304 is shown. The trays 304 can reduce the likelihood of the fiber straying described above. The assembly 300 extends from a proximal end 331 to a distal end 332 along a first axis 333. The assembly 300 extends from a first side 334 to a second side 336 along a second axis 338. The assembly 300 extends from a top 340 to a bottom 342 along a third axis 344. The first, second and third axes 333, 338 and 344 are mutually perpendicular. The first and second axes define a horizontal plane and the third axis 344 is a vertical axis. The assembly has a length parallel to the first axis 333, a width parallel to the second axis 338, and a height parallel to the third axis 344.

As used herein, terms such as length, width, height, proximal, distal, top, bottom, horizontal and vertical are for ease of description in relating orientations of components of a given assembly to one another. These terms do not limit how the assembly may be situated in practice.

Relative to the axes 333, 338 and 344, each tray 304 has a maximum width W1 parallel to axis 338, a maximum height H1 parallel to the axis 344, and a maximum length L1 parallel to the axis 333.

The assembly 300 can substitute for the tower 240 and trays 262 of the organizer 260 of FIG. 1.

The tower 102 includes twelve hinge locations 134. However, due to the maximum height H1 of the tray wall, which is required to accommodate fiber ribbons at the surface 306, only every other of the twelve hinge locations 134 can be occupied, such that the tower 102 pivotally supports a maximum of six of the trays 304 mounted at every other one of the hinge locations 134.

Each tray 304 has a fiber management surface 306 and a peripheral wall 308 that follows an outer perimeter of the fiber management surface 306. Fiber retaining tabs 314 project from the wall 308 defining a space 316 between the retaining tabs 314 and the fiber management surface 306 in which fibers can be routed. The space 316 is sufficient to accommodate the transverse width of fiber ribbons.

The fiber management surface includes mounting structures 319 that include tapered openings 321 and a cantilever stop 325. The mounting structures 319 are configured to lockingly receive dovetailing projections of splice holder blocks (splice holders) 310 and 311 to mount the splice holder blocks to the support surface 306. The splice holder block 310 includes a plurality of splice body receivers 312, and each splice body receiver 312 is configured to hold a splice body of a single fiber splice. The splice holder block 311 includes a plurality of splice body receivers 313 and each splice body receiver 313 is configured to hold a splice body of a multi-fiber splice, such as a splice body for fiber ribbons.

Fibers, including both loose fibers and fiber ribbons (e.g., rollable ribbons) can enter a tray 304 via a tower fiber channel 118 of the tower 102. Typically, such fibers are routed from a cable (e.g., a feeder cable) entering the closure in which the assembly 300 is to be housed. The jacket of the cable is stripped to expose optical fibers and an unstripped portion of the jacket is fixed at a cable fixation area of the closure. The optical fibers are then guided from the cable to the base of the organizer, from the base of the organizer to the tower, and from a tower fiber channel onto one of the trays 304. The tray 304 supports the fibers' splices to other fibers routed into the closure via another cable (e.g., a drop cable) entering and affixed to the closure.

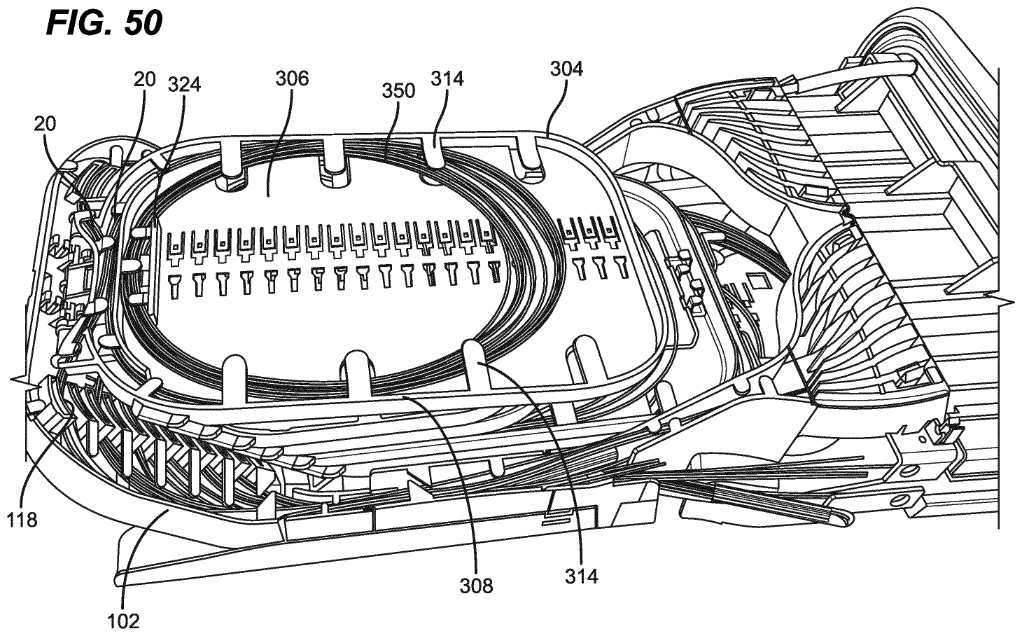

Fiber ribbons and loose fibers can enter the tray 304 via an entryway 320 to a channel 322 of the tray 304, which is in communication with the rest of the fiber management surface 306, allowing the fiber ribbons and loose fibers to be routed to the splice holders. The tray 304 includes two such entryways 320 and channels 322 at opposite sides allowing for fiber entry onto the tray 304 from both sides of the tray and from the tower fiber channels on both sides of the tray. Typically, one or more loops 350 (FIG. 50) of the fiber ribbons are stored at the fiber management surface 306, with the tabs 314 and other routing and guiding structures 324 facilitating loop storage within permitted bend radius limitations. The splice holder 311 supports fiber ribbon to fiber ribbon splice bodies, while the splice holder 310 supports individual fiber splice bodies. The individual fiber splices can be between loose fibers or from individual fibers of a fiber ribbon to loose fibers. Thus, the tray 304 can support multiple splice and fiber routing and management arrangements.

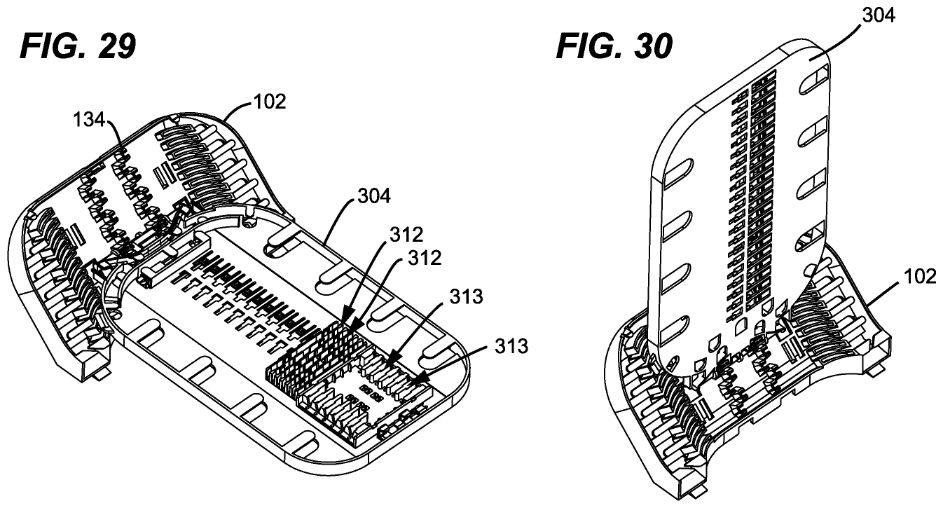

Adjacent the channels 322 is a hinge portion 326 that includes hinge components. The hinge components include square bars 330 that are received in clips 132 of the tower 102. The interfacing of the square bars 330 and the clips 132 allows the tray 304 to frictionally hold in a pivoted up position (FIG. 30) until sufficient torque is applied to overcome the frictional fit between square bar and clip to return the tray 304 to the pivoted down position (FIG. 29). The clips 132 are hinge components of the tower 102 that are complementary to the hinge components 330 of the trays 304. The hinge components 132 of the tower 102 define a total of twelve hinge locations 134. Pivoting of one of the trays permits access to the fiber management surface of the tray below it.

The fiber management surface 306, which includes a recessed portion 307 and a non-recessed portion 309 lies substantially parallel to the reference plane defined by the axes 333 and 338. The hinge components 330 define a pivot axis 360 that is parallel to the second axis 338.

Walls 364, 366 extend from the fiber management surface 306 parallel to the third axis 344. The wall 364 can be the same as the peripheral wall 308. The walls 364 and 366 define the channels 322 that merge into the channel 323. Each of the channels 322 defines a channel entryway 320 through which optical fibers exterior to the tray can enter the tray. The channel entryways 320 are thus substantially U-shaped in vertical plane cross-section, being defined by the walls 364 and 366 and portions 368, 370 of the fiber management surface 306 connecting the walls 364 and 366. The wall 364 includes a substantially triangular shaped fiber guiding block 386 positioned at each channel entryway 320 and at least partially within the corresponding channel 320.

Near each of the channels 322, a finger 372 projects proximally from an exterior side 374 of one of the walls 364 to a free, proximal end 376. The free, proximal end 376 of the finger 372 is positioned distally of the proximal end 382 of the channel entryway. An elongate dimension of the finger 372 is parallel to the first axis 333. The finger 372 extends proximally beyond a distal end 378 of the corresponding channel entryway 320. An elongate dimension of the finger is parallel to the first axis 333. The guiding block 386 is positioned at the distal end 378 of the channel entryway 320. Optionally, as shown, the finger 372 includes a main body 384 and a first prong 392 extending proximally from the main body 384.

There is a material void 380 between each finger 372 and the corresponding entryway 320. The material void 380 extends continuously between the top and the bottom of the tray and beyond the top and beyond the bottom of the tray parallel to the axis 344. In some examples, the material void 380 has a length parallel to the axis 333 that is greater than a maximum length parallel to the axis 333 of the channel entryway 320. The material void 380 has a width parallel to the second axis 338 that is greater than a maximum width of the finger 372 parallel to the second axis.

A fiber retention tab 388 projects horizontally from the wall 366 between the channel entryway 322 and the finger 372. Additional fiber retentions tabs 390 extend from the wall 366 above the channel 323. The tabs 390 project partially upward such that portions of the tabs 390 are above the wall 366. The height of the wall 366 corresponds to the height of the hinge portion 326, which is sized to be received in the complementary hinge components of the tower 102. Thus, to accommodate fiber ribbons in the channel 323, the tabs 390 are elevated above the top of the wall 366. In this manner, the tower 102, which can accommodate up to 12 loose fiber-only fiber management trays, can alternatively accommodate up to six of the trays 304, which can receive both loose fibers and fiber ribbons.

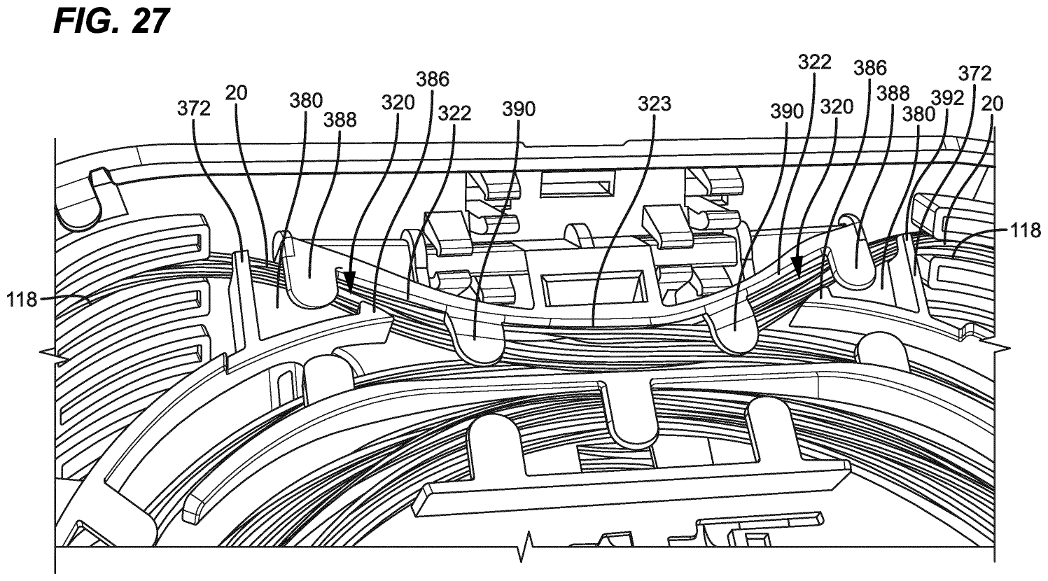

Referring to FIG. 27, the tray 304 is in a pivoted down position. Two rollable fiber ribbons 20 enter the opposing channels 322 via the entryways 320 and cross over each other in the channel 323. The ribbons 20 enter entryways 320 from outside the trays 304 through the material voids 380 being guided around the free, proximal end 382 of the finger 372 and the guiding block 386, and being retained under the fiber retainer tab 388. The finger 372 includes a proximally projecting prong 392 extending from a main body 394 of the finger 372. The fiber ribbon 20 can be guided or retained by the prong 392 as it is routed around the free proximal end of the finger 372.

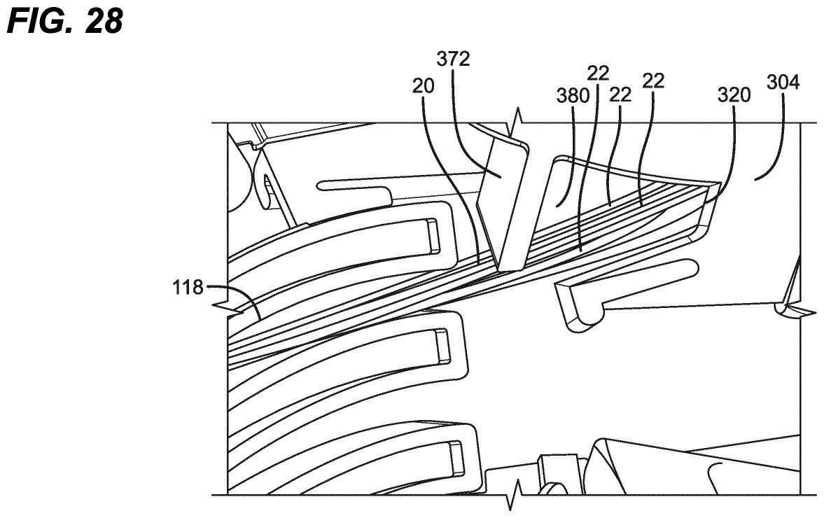

Referring to FIG. 28, the tray 304 is in the pivoted up position. As shown, the overall routing path of the rollable ribbon 20 is substantially unchanged from the pivoted down position routing configuration of FIG. 27. As shown in FIG. 28, none of the individual fibers 22 of the rollable fiber ribbon 20 are straying from the overall fiber path as the fibers 22 exit the tower fiber channel 118 and extend from there through the entryway 320. The arrangement and relative sizing and positioning of one or more, or all of, the finger 372, the prong 392, the material void 380, and the triangular shaped fiber guiding block 386 allow for sufficient freedom in range of motion of the individual fibers 22 of the ribbon 20, while also providing sufficient overall routing path restricting structures, such that the individual fibers 22 of the ribbon 20 do not substantially deviate from the overall path of the fiber ribbon 20 as it is guided from the channel 118 into the channel 322, while permitting the desired overall routing path of the ribbon 20 to be maintained.

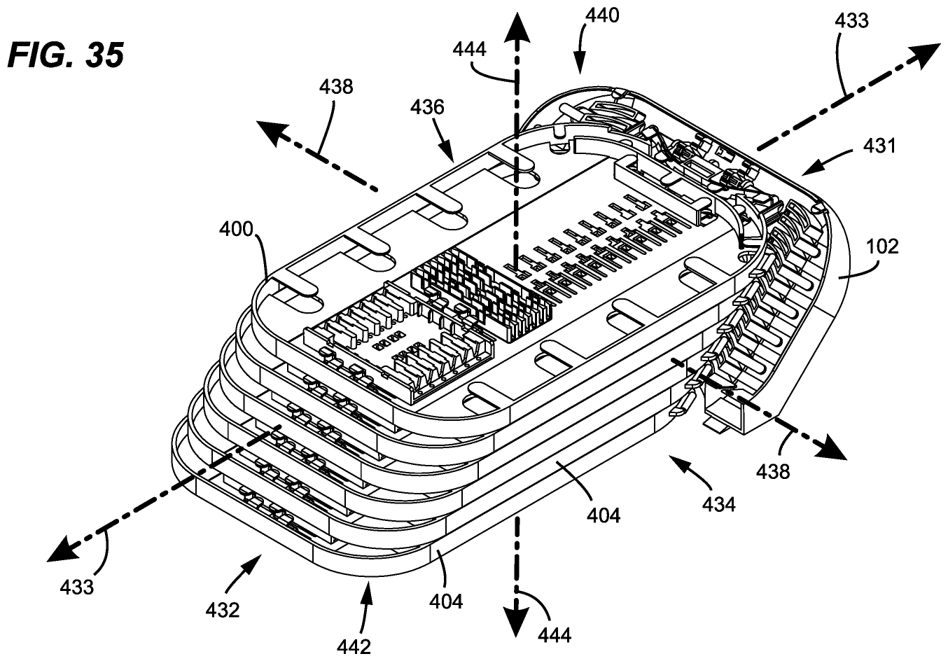

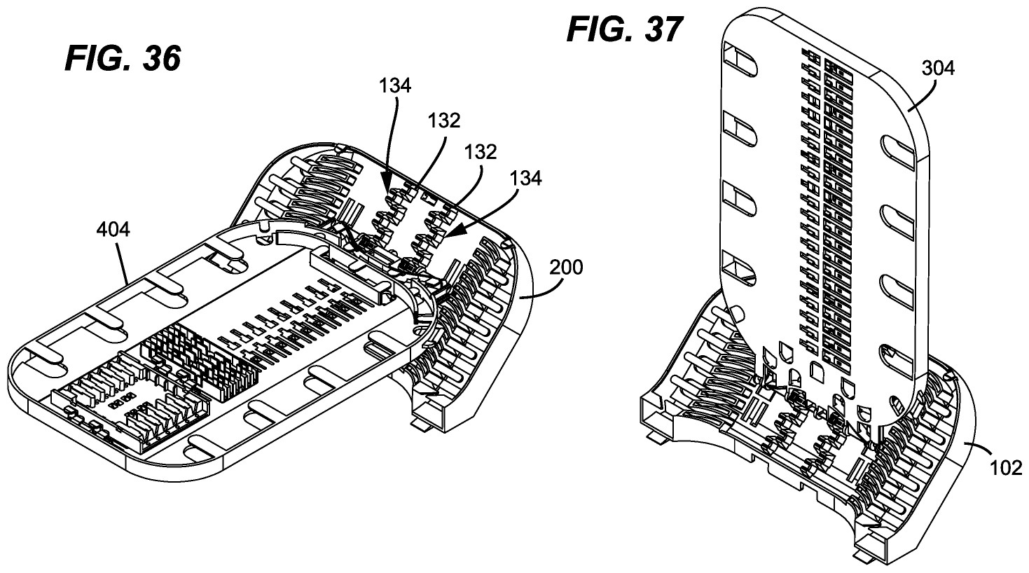

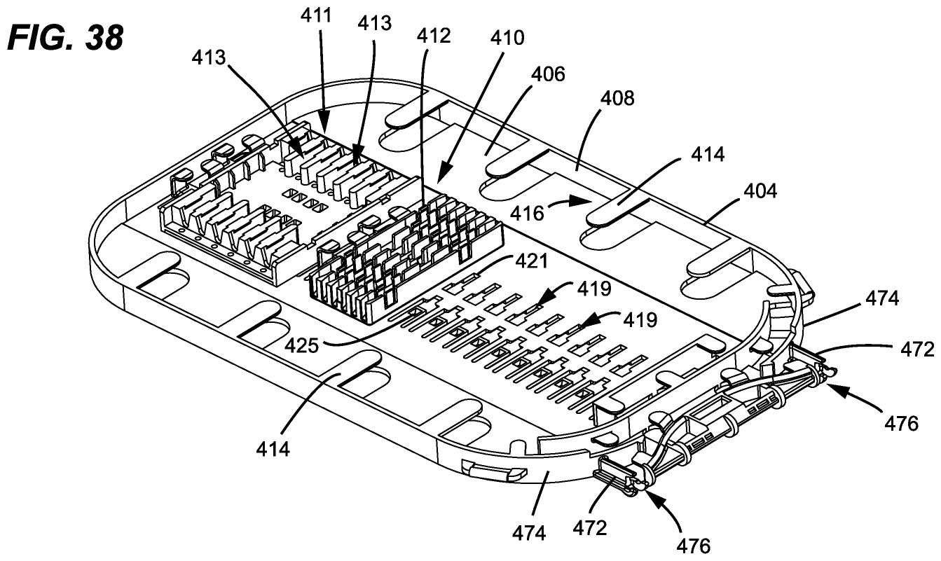

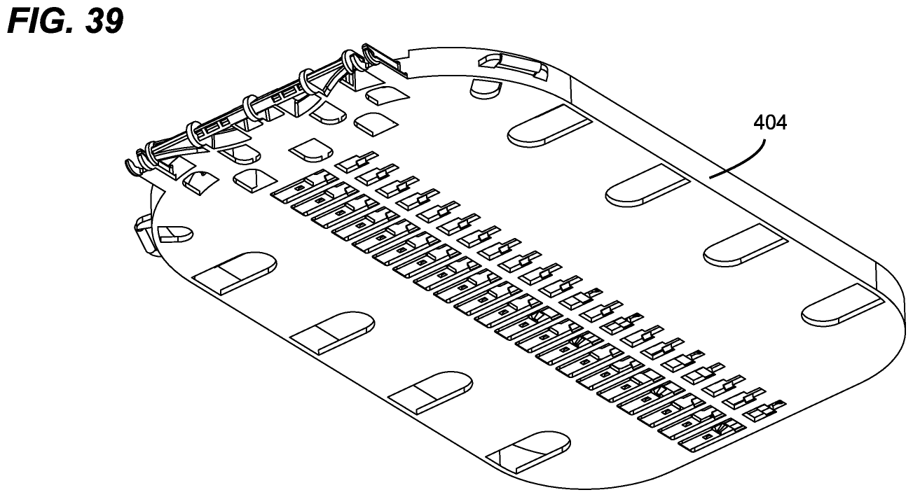

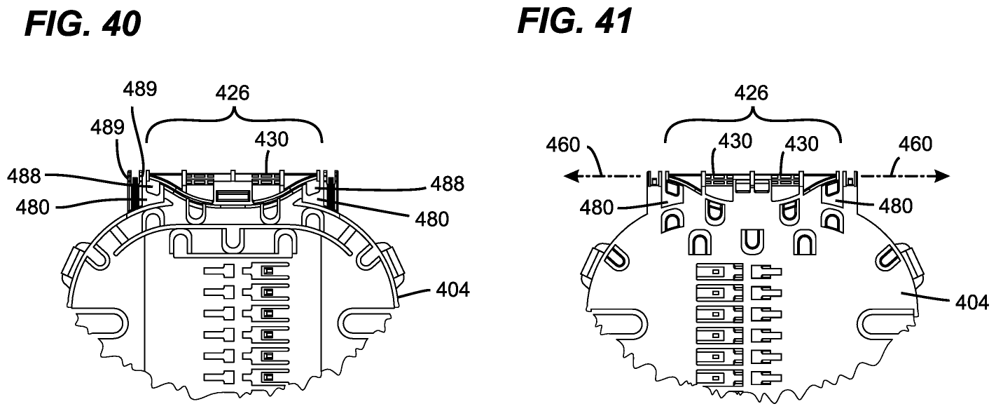

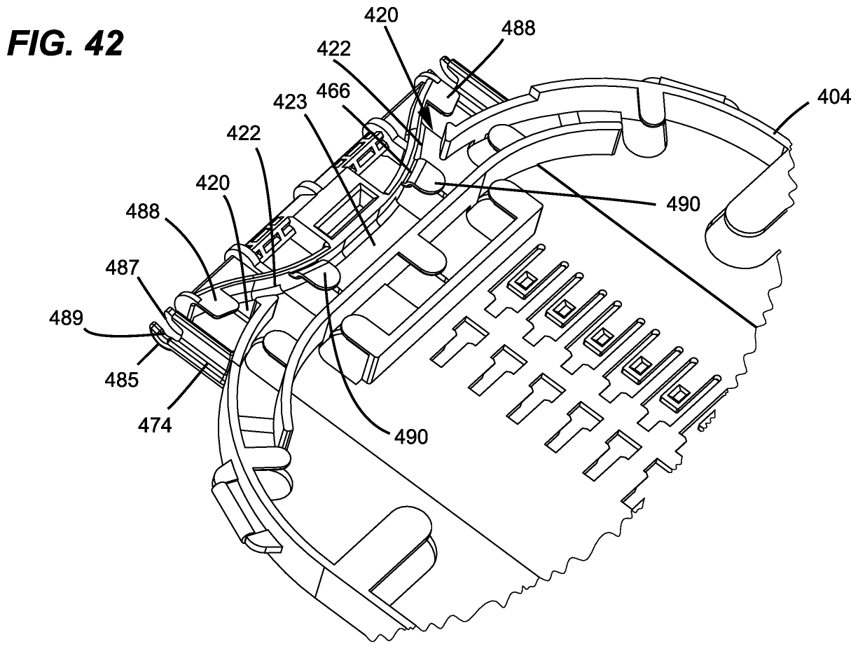

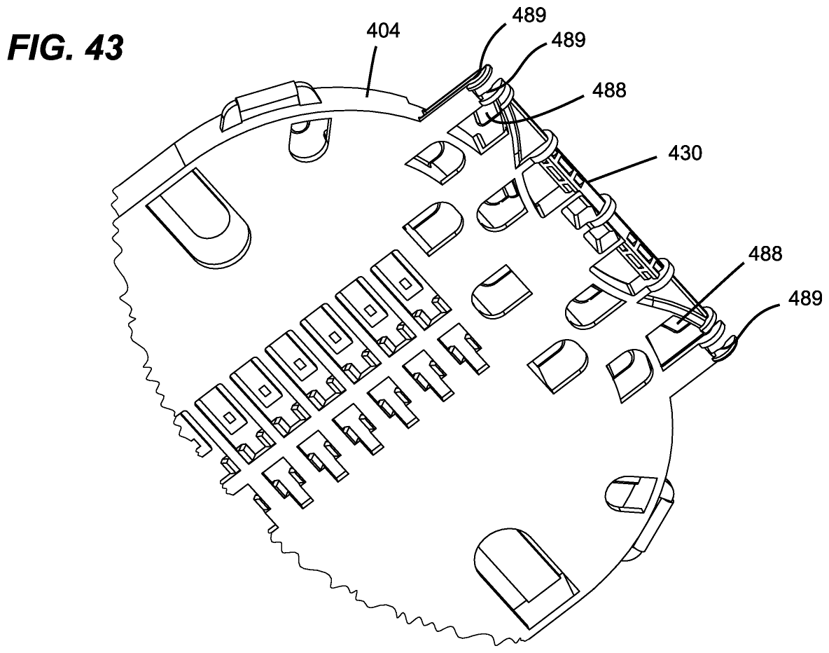

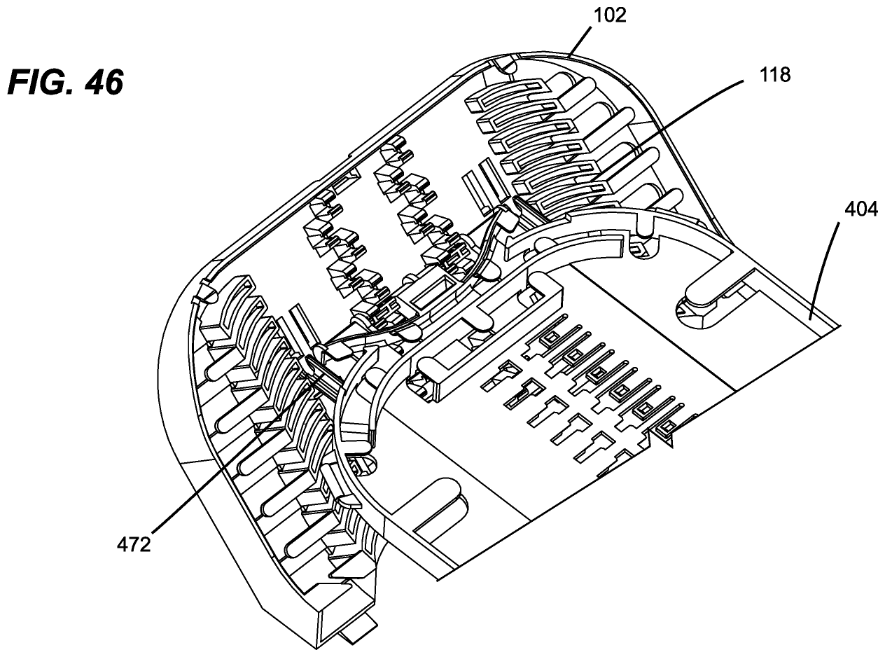

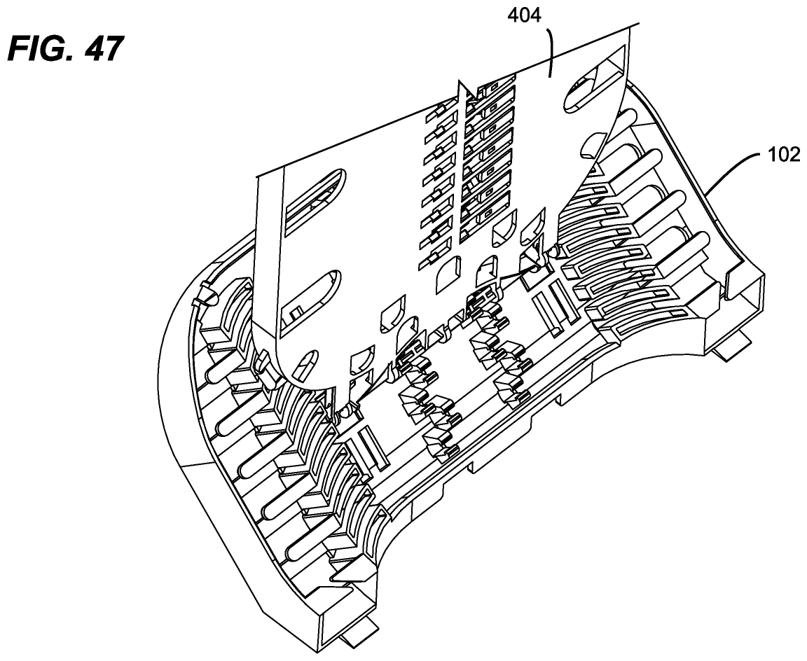

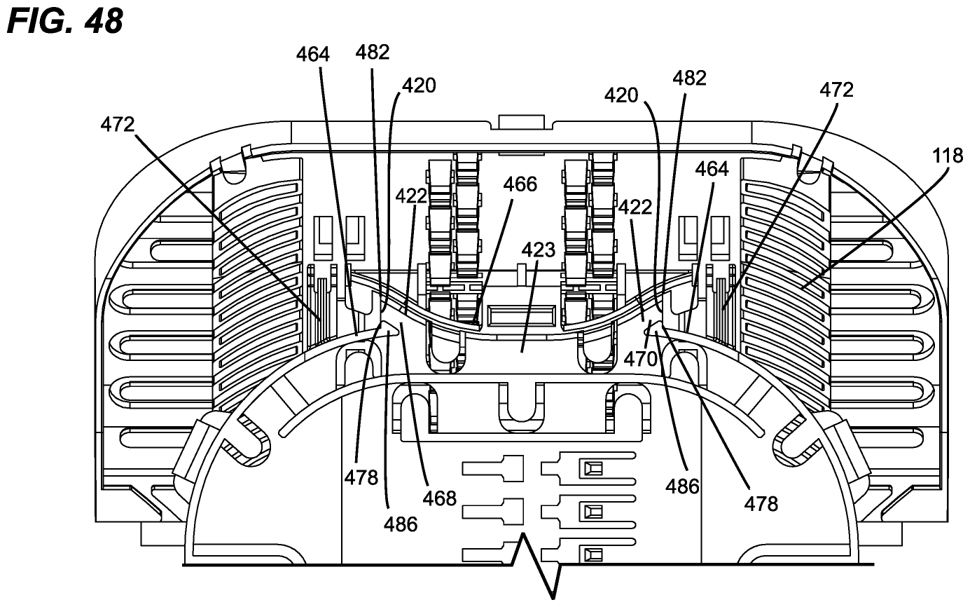

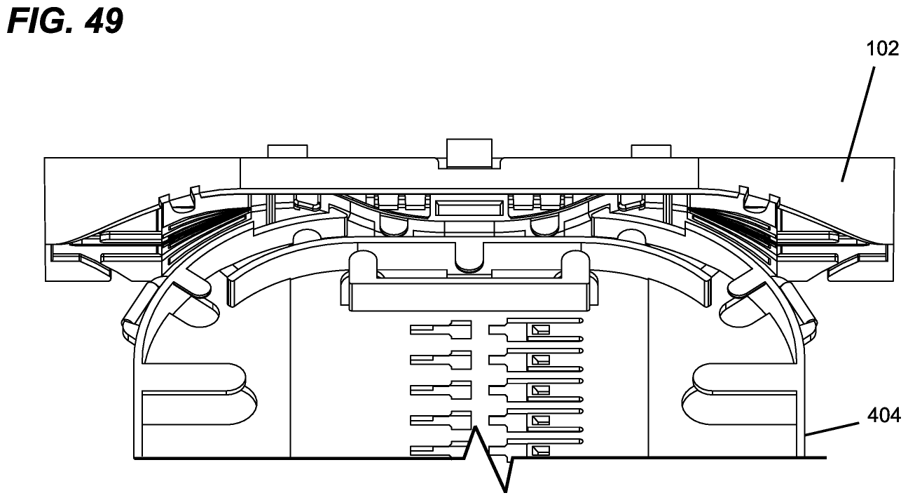

Referring to FIGS. 35-49, an assembly 400 having the same tower 102 described above and a further embodiment of trays 404 is shown. The trays 404 can reduce the likelihood of the fiber straying described above. The assembly 400 extends from a proximal end 431 to a distal end 432 along a first axis 433. The assembly 400 extends from a first side 434 to a second side 436 along a second axis 438. The assembly 400 extends from a top 440 to a bottom 442 along a third axis 444. The first, second and third axes 433, 438 and 444 are mutually perpendicular. The first and second axes define a horizontal plane and the third axis 444 is a vertical axis. The assembly has a length parallel to the first axis 433, a width parallel to the second axis 438, and a height parallel to the third axis 344.

The assembly 400 can substitute for the tower 240 and trays 262 of the organizer 260 of FIG. 1.

The tower 102 includes twelve hinge locations 134. However, due to the maximum height of the tray wall, which is required to accommodate fiber ribbons at the surface 406, only every other of the twelve hinge locations 134 can be occupied, such that the tower 102 pivotally supports a maximum of six of trays 404 mounted at every other one of the hinge locations 134.

Each tray 404 has a fiber management surface 406 and a peripheral wall 408 that follows an outer perimeter of the fiber management surface 406. Fiber retaining tabs 414 project from the wall 408 defining a space 416 between the retaining tabs 414 and the fiber management surface 406 in which fibers can be routed. The space 416 is sufficient to accommodate the transverse width of fiber ribbons.

The fiber management surface includes mounting structures 419 that include tapered openings 421 and a cantilever stop 425. The mounting structures 419 are configured to lockingly receive dovetailing projections of splice holder blocks (splice holders) 410 and 411 to mount the splice holder blocks to the support surface 406. The splice holder block 410 includes a plurality of splice body receivers 412, and each splice body receiver 412 is configured to hold a splice body of a single fiber splice. The splice holder block 411 includes a plurality of splice body receivers 413 and each splice body receiver 413 is configured to hold a splice body of a multi-fiber splice, such as a splice body for fiber ribbons.

Fibers, including both loose fibers and fiber ribbons (e.g., rollable ribbons) can enter a tray 404 via a tower fiber channel 118 of the tower 102. Typically, such fibers are routed from a cable (e.g., a feeder cable) entering the closure in which the assembly 400 is to be housed. The jacket of the cable is stripped to expose optical fibers and an unstripped portion of the jacket is fixed at a cable fixation area of the closure. The optical fibers are then guided from the cable to the base of the organizer, from the base of the organizer to the tower, and from a tower fiber channel 118 onto one of the trays 404. The tray 404 supports the fiber's splice to another fiber routed into the closure via another cable (e.g., a drop cable) entering and affixed to the closure.

Fiber ribbons and loose fibers can enter the tray 404 via an entryway 420 to a channel 422 of the tray 404, which is in communication with the rest of the fiber management surface 406, allowing the fiber ribbons and loose fibers to be routed to the splice holders. The tray 404 includes two such entryways 420 and channels 422 at opposite sides allowing for fiber entry onto the tray 404 from both sides of the tray and from the tower fiber channels on both sides of the tray. Typically, one or more loops of the fiber ribbons are stored at the fiber management surface 406, with the tabs 414 and other routing and guiding structures or modules having guiding structures facilitating loop storage at the management surface 406 within permitted bend radius limitations. The splice holder 411 supports fiber ribbon to fiber ribbon splice bodies, while the splice holder 410 supports individual fiber splice bodies. The individual fiber splices can be between loose fibers or from individual fibers of a fiber ribbon to loose fibers. Thus, the tray 404 can support multiple splice and fiber routing and management arrangements.

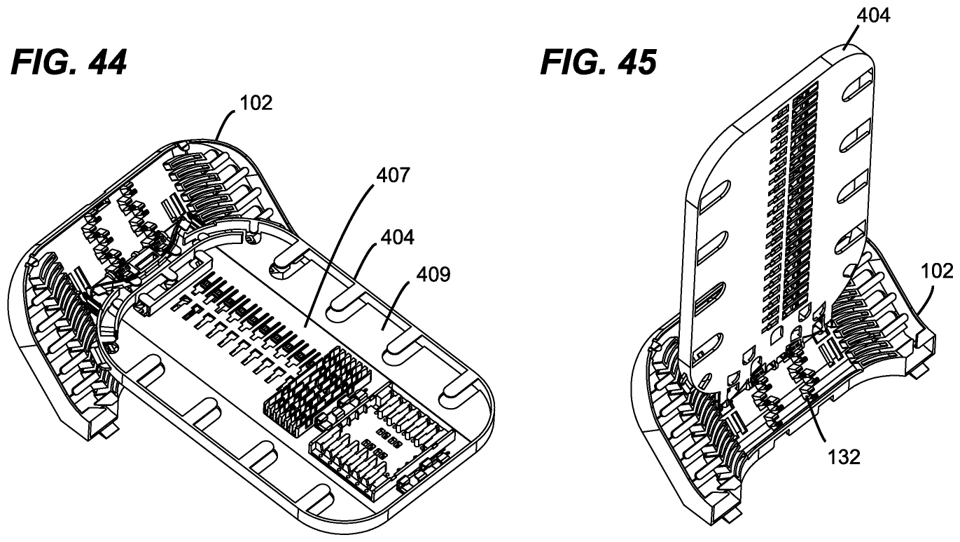

Adjacent the channels 422 is a hinge portion 426 that includes hinge components. The hinge components include square bars 430 that are received in clips 132 of the tower 102. The interfacing of the square bars 430 and the clips 132 allows the tray 404 to frictionally hold in a pivoted up position (FIG. 45) until sufficient torque is applied to overcome the frictional fit between square bar and clip to return the tray 404 to the pivoted down position (FIG. 44). The clips 132 are hinge components of the tower 102 that are complementary to the hinge components 430 of the trays 440.

The fiber management surface 406, which includes a recessed portion 407 and a non-recessed portion 409 lies substantially parallel to the reference plane defined by the axes 433 and 438. The hinge components 428 define a pivot axis 460 that is parallel to the second axis 438.

Walls 464, 466 extend from the fiber management surface 406 parallel to the third axis 444. The wall 464 can be the same as (e.g., a continuation of) the peripheral wall 408. The walls 464 and 466 define the channels 422 that merge into the channel 423. Each of the channels 422 defines a channel entryway 420 through which optical fibers exterior to the tray can enter the tray. The channel entryways 420 are thus substantially U-shaped in vertical plane cross-section, being defined by the walls 464 and 466 and portions 468, 470 of the fiber management surface 406 connecting the walls 464 and 466. The wall 464 include a substantially triangular shaped fiber guiding block 486 positioned at each channel entryway 420 and at least partially within the corresponding channel 420.

Near each of the channels 422, a finger 472 projects proximally from an exterior side 474 of the wall 464 to a free, proximal end 476. The free, proximal end 476 of the finger 472 is positioned distally of the proximal end 482 of the channel entryway. An elongate dimension of the finger 472 is parallel to the first axis 433. The finger 472 thus extends proximally beyond a distal end 478 of the corresponding channel entryway 420 and proximally beyond the proximal end 482 of the corresponding channel entry 420. The finger 472 includes a main body 484 and a first and second spaced apart prongs 485 and 487 extending proximally from the main body 484. Each prong 485, 487 defines a notch 489. Between the prongs 485 is a material void 499. The notches 489 are spaced apart from each other can be generally aligned parallel to the axis 438.

There is a material void 480 between each finger 472 and the corresponding entryway 420. The material void 480 extends continuously between the top and the bottom of the tray and beyond the top and beyond the bottom of the tray parallel to the axis 444. The material void 480 has a length parallel to the axis 433 that is greater than a maximum length parallel to the axis 433 of the channel entryway 420.

A fiber retention tab 488 projects horizontally from the wall 466 between the channel entryway 420 and the finger 472. Additional fiber retentions tabs 490 extend from the wall 466 above the channel 423. The tabs 490 project partially upward such that portions of the tabs 490 are above the wall 466. The height of the wall 466 corresponds to the height of the hinge portion 426, which is sized to be received in the complementary hinge components of the tower 102. Thus, to accommodate fiber ribbons in the channel 423, the tabs 490 are elevated above the top of the wall 466. In this manner, the tower 102, which can accommodate up to 12 loose fiber-only fiber management trays, can alternatively accommodate up to six of the trays 404, which can receive both loose fibers and fiber ribbons.

Rollable fiber ribbon can enter entryways 420 from outside the trays 404 through the material voids 480 being guided around the free, proximal end 482 of the finger 472, optionally via the notches 489 and the guiding block 486, and being retained under the fiber retainer tab 488. The fiber ribbon can be guided by the prongs 485 and 487, as well as the notches 489 as the ribbon is routed around the free proximal end of the finger 472.

The arrangement and relative sizing and positioning of one or more, or all of, the finger 472, the prongs 485 and 487, the notches 489, the material void 480, the material void 499, and the triangular shaped fiber guiding block 486 allow for sufficient freedom in range of motion of the individual fibers of the ribbon, while also providing sufficient overall routing path restricting structures, such that the individual fibers of the ribbon do not substantially deviate from the overall path of the fiber ribbon as it is guided from the channel 118 into the channel 422, while permitting the desired overall routing path of the ribbon to be maintained.

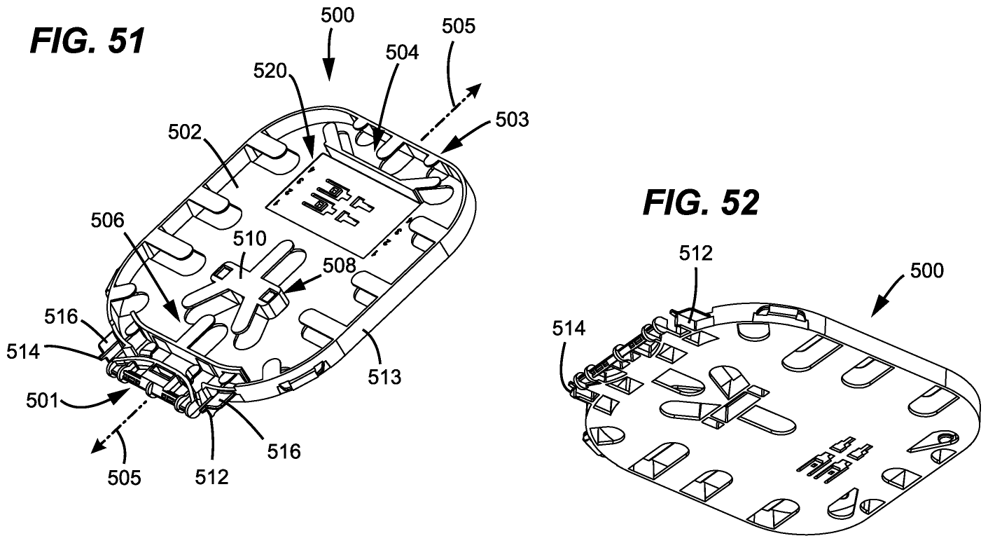

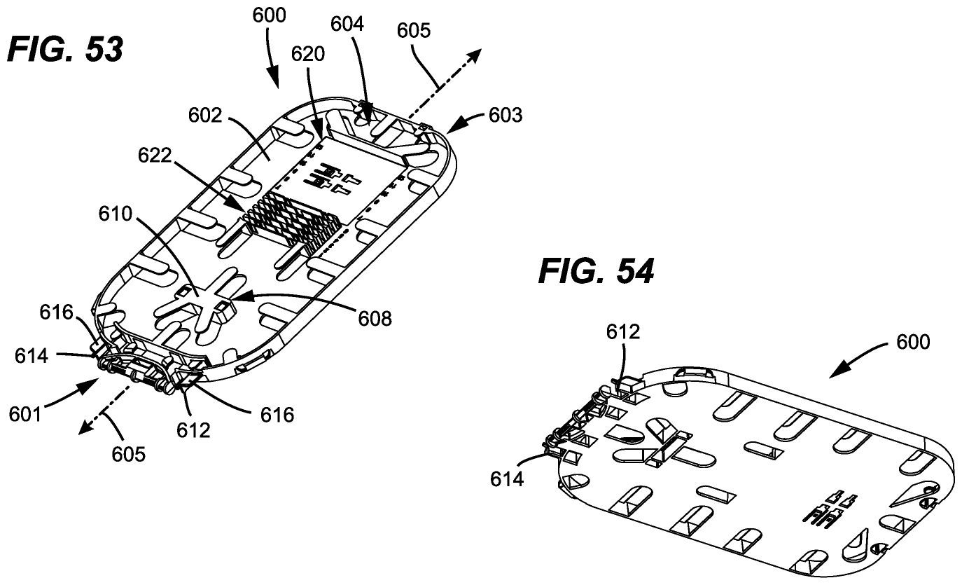

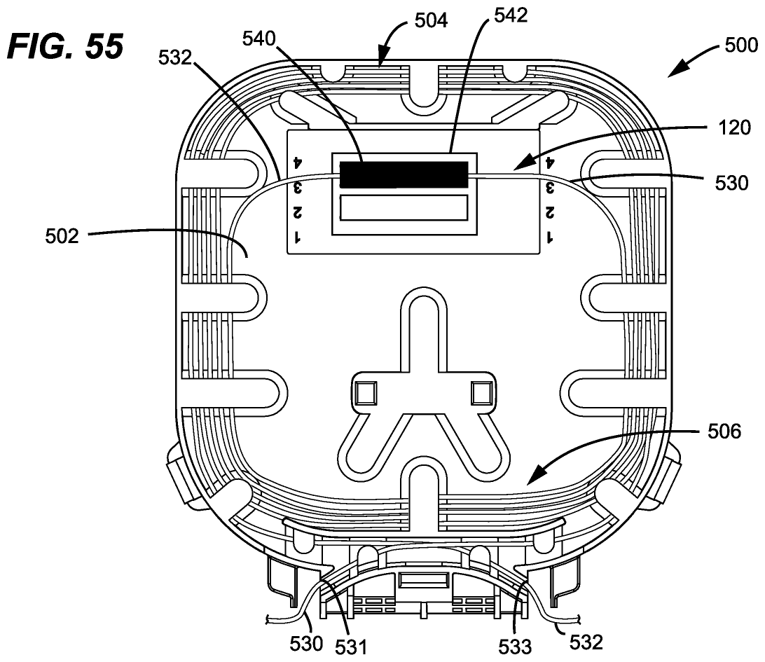

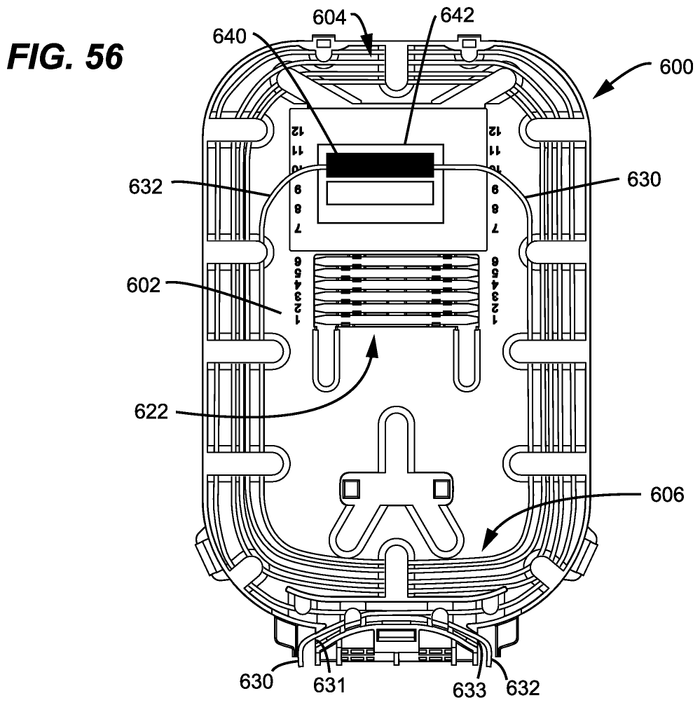

Referring to FIGS. 51-56 additional example embodiments of fiber management trays 500, 600 are shown. The trays 500, 600 include many features of other trays described herein and can be pivotally mounted to one or more of the towers described herein in the manner described herein. The following discussion will focus mainly on structural differences between the trays 500, 600 and other trays described herein, as well as example routing configurations for rollable fiber ribbons. Characteristics of the routing configurations shown In FIGS. 55 and 56 can be applied to other trays shown and described herein.

The tray 500 extends from a proximal end 501 to a distal end 503 along an axis 505, and includes a fiber management surface 502. Together with the fiber management surface 502, the tray 500 defines a distal looping channel 504 and a proximal looping channel 506 defined by walls projecting away from the fiber management surface 502 and fiber retainer tabs. The proximal looping channel 506 defines part of a spooling region 508 that includes a spooling structure 510. In the routing configuration of FIG. 55, the spooling region 508 is not used for looping rollable fiber ribbons except for the proximal looping channel 506.

Fingers 512 and 514 project proximally from an exterior side of a wall 13 of the tray and function as one or more of the fingers described herein. Each finger 512, 514 is reinforced by a flange 516 that connects the finger 512, 514 to the wall 513.

The fiber management surface 502 defines a splice holder region 520 configured to support splice holders that can hold multi-splice bodies, such as splice bodies of ribbon to ribbon splices.

The tray 600 extends from a proximal end 601 to a distal end 603 along an axis 605, and includes a fiber management surface 602. Together with the fiber management surface 602, the tray 600 defines a distal looping channel 604 and a proximal looping channel 606 defined by walls projecting away from the fiber management surface 602 and fiber retainer tabs. The proximal looping channel 606 defines part of a spooling region 608 that includes a spooling structure 610. In the routing configuration of FIG. 56, the spooling region 608 is not used for looping rollable fiber ribbons except for the proximal looping channel 606.

Fingers 612 and 614 project proximally from an exterior side of a wall 13 of the tray and function as one or more of the fingers described herein. Each finger 612, 614 is reinforced by a flange 616 that connects the finger 612, 614 to the wall 613.

The fiber management surface 602 defines a splice holder region 620 configured to support splice holders that can hold multi-splice bodies, such as splice bodies of ribbon to ribbon splices. The fiber management surface 602 also supports a splice holder 622 proximally positioned relative to the splice holder region 620. The splice holder 622 is configured to hold individual splice bodies.

Referring to FIG. 55, two rollable fiber ribbons 530 and 532 are schematically illustrated routed on the fiber management surface 502. The ribbons 530, 532 are routed in opposite directions around the tray 500, one counterclockwise, and the other clockwise. Ends of the ribbons 530, 532 are spliced to each other at a multi-splice body 540 held by a splice holder 542 mounted to the region 520.

The ribbon 530 has a longitudinal length extending from a position 531 on the ribbon 530 where the ribbon 530 enters the tray 500. The ribbon 532 has a longitudinal length extending from a position 533 on the ribbon 532 where the ribbon 532 enters the tray 500.

The longitudinal length of each ribbon 530, 532 is in a range from about 60 centimeters to about 100 centimeters. In some examples, the longitudinal length of each ribbon 530, 532 is in a range from about 70 centimeters to about 90 centimeters. In some examples, the longitudinal length of each ribbon 530, 532 is about 80 centimeters.

The lengths of the ribbons 530 and 532 are looped on the fiber management surface 502 through the channels 504 and 506.

As shown, the length of each ribbon 530, 532 is looped into fewer than three full loops on the fiber management surface 502 before entering the region 520. In some examples, each ribbon is looped into between 0 and 1 full loop. In some examples, each ribbon is looped into between 1 and 2 full loops. In some examples, each ribbon is looped into between 2 and 3 full loops. Referring to FIG. 56, two rollable fiber ribbons 630 and 632 are schematically illustrated routed on the fiber management surface 602. The ribbons 630, 632 are routed in opposite directions around the tray 600, one counterclockwise, and the other clockwise. Ends of the ribbons 630, 632 are spliced to each other at a multi-splice body 640 held by a splice holder 642 mounted to the region 620.

The ribbon 630 has a longitudinal length extending from a position 631 on the ribbon 630 where the ribbon 630 enters the tray 600. The ribbon 632 has a longitudinal length extending from a position 633 on the ribbon 632 where the ribbon 632 enters the tray 600.

The longitudinal length of each ribbon 630, 632 is in a range from about 60 centimeters to about 130 centimeters. In some examples, the longitudinal length of each ribbon 630, 632 is in a range from about 100 centimeters to about 130 centimeters. In some examples, the longitudinal length of each ribbon 630, 632 is about 120 centimeters.

The lengths of the ribbons 630 and 632 are looped on the fiber management surface 602 through the channels 604 and 606.

As shown, the length of each ribbon 630, 632 is looped into fewer than three full loops on the fiber management surface 602 before entering the region 620. In some examples, each ribbon is looped into between 0 and 1 full loop. In some examples, each ribbon is looped into between 1 and 2 full loops. In some examples, each ribbon is looped into between 2 and 3 full loops.

Limiting the number of loops of the ribbons in this manner as shown in FIGS. 55 and 56 can minimize unwanted twisting and torsion points in a ribbon fiber and, particularly, a rollable ribbon fiber. Such twists and torsion points can detrimentally result in optical signal loss. Rollable fiber ribbons can be particularly susceptible to signal loss from twisting or torsion due to the staggered nature of the bonding locations between the individual fibers, which allows the ribbon to “roll”. By minimizing the number of loops of rollable fiber ribbons on a fiber management tray as demonstrated, for example, by the routing configurations of FIGS. 55 and 56, optical transmission characteristics of the rollable fiber ribbons can be maximized.

Having described the preferred aspects and embodiments of the present disclosure, modifications and equivalents of the disclosed concepts may readily occur to one skilled in the art. However, it is intended that such modifications and equivalents be included within the scope of the claims which are appended hereto.

What is claimed is:

1. A fiber management tray for managing optical fibers, the tray extending from a proximal end to a distal end along a first axis defining a length of the tray, from a first side to a second side along a second axis perpendicular to the first axis, the second axis defining a width of the tray, and from a top to a bottom along a third axis perpendicular to the first and second axes, the third axis defining a height of the tray, the first and second axes defining a reference plane, the tray comprising:
a fiber management surface lying parallel to the reference plane;
one or more hinge components defining a pivot axis that is parallel to the second axis;
walls extending from the fiber management surface parallel to the third axis, the walls and the fiber management surface defining a channel, the channel including a channel entryway through which optical fibers exterior to the tray can enter the tray, the channel entryway being defined by the walls and a portion of the fiber management surface connecting the walls;
a finger projecting proximally from an exterior side of one of the walls to a free, proximal end of the finger, the finger extending proximally beyond a distal end of the channel entryway,
wherein there is a material void between the finger and the entryway.

2. The fiber management tray of claim 1, wherein an elongate dimension of the finger is parallel to the first axis.

3. The fiber management tray of any of claims 1-2, wherein the free, proximal end of the finger is positioned proximally beyond a proximal end of the channel entryway.

4. The fiber management tray of any of claims 1-2, wherein the free, proximal end of the finger is positioned distally of a proximal end of the channel entry way.

5. The fiber management tray of any of claims 1-4, wherein the tray the material void extends continuously between the top and the bottom of the tray and beyond the top and beyond the bottom of the tray parallel to the third axis.

6. The fiber management tray of claim 5, wherein the material void has a length parallel to the first axis that is greater than a maximum length parallel to the first axis of the channel entryway.

7. The fiber management tray of claim 5 or 6, wherein the material void has a width parallel to the second axis that is greater than a maximum width of the finger parallel to the second axis.

8. The fiber management tray of any of claims 1-7, wherein the channel has a substantially U-shaped cross-sectional profile.

9. The fiber management tray of any of claims 1-8, wherein the finger includes a main body and a first prong extending proximally from the main body.

10. The fiber management tray of claim 9, wherein the finger includes a second prong extending proximally from the main body, the first and second prongs being spaced apart from each other parallel to the second axis with a material void therebetween.

11. The fiber management tray of claim 10, wherein the first and second prongs each define a notch.

12. The fiber management tray of claim 11, wherein the notches of the first and second prongs are aligned parallel to the second axis.

13. The fiber management tray of any of claims 1-12, wherein one of the walls includes a substantially triangular shaped fiber guiding block positioned at the channel entryway and at least partially within the channel.

14. The fiber management tray of any of claims 5-7, further comprising a fiber retention tab projecting parallel to the first axis from one of the walls between the channel entryway and the finger.

15. The fiber management tray of any of claims 1-14, further comprising one or more channel fiber retentions tabs above the channel, the one or more channel fiber retention tabs extending from a first of the walls, and being partially above the first wall along the third axis.

16. The fiber management tray of any of claims 1-15,
wherein the entryway is a first channel entryway, the channel including a second channel entryway on an opposite side of the tray;
wherein the finger is a first finger, the tray further comprising a second finger projecting proximally from an exterior side of one of the walls to a free, proximal end of the second finger, the second finger extending proximally beyond a distal end of the second channel entryway; and
wherein the material void is a first material void, a second material void being positioned between the second finger and the second entryway.

17. The fiber management tray of any of claims 1-16, wherein the tray includes mounting structures configured to mount splice holders.

18. The fiber management tray of claim 17, wherein the tray supports a first splice holder holding single fiber splices and a second splice holder holding multi-fiber splices.

19. The fiber management tray of claim 18, wherein the multi-fiber splices are splices of rollable ribbon fiber splices.

20. The fiber management tray of any of claims 1-19, wherein a first portion of one of the walls defining the channel has a smaller maximum dimension parallel to the third axis than a second portion of a wall projecting from the fiber management surface along parallel to the third axis at a perimeter of the fiber management surface.

21. An assembly, comprising:
a tower, the tower including a body defining a plurality of tower guide channels and hinge components at each of a plurality of hinge positions located between columns of the guide channels; and
a plurality of the fiber management trays according to any of claims 1-20, the hinge components of the trays being coupled to some of the hinge components of the tower.

22. The assembly of claims 21, wherein no more than every other of the hinge positions has one of the trays coupled to the corresponding hinge components of the tower.

23. A fiber optic closure, comprising:
housing pieces that cooperate to form a sealable and re-enterable closure volume;
one or more fiber optic cables entering the closure volume through ports defined by one or more of the housing pieces, the fiber optical cables including rollable fiber ribbons; and
an assembly according claim 21 or 22 positioned within the closure volume.

24. A method, comprising:
guiding a rollable fiber ribbon through a first of the tower guide channels of the tower of the assembly according to claim 21 or 22; and
guiding the rollable fiber ribbon from the first tower guide channel into the channel of a first of the trays of claim 21 or 22 via the channel entryway.

25. The method of claim 24, further comprising guiding the rollable fiber ribbon around the proximal, free end of the finger.

26. The method of claim 24 or 25, further comprising individually splicing fibers of the rollable fiber ribbon to loose individual fibers, and holding splice bodies of the spliced fibers at a splice holder mounted to one of the trays of the assembly.

27. The method of any of claims 24-26,
wherein the finger of the first tray includes a main body and a first prong extending proximally from the main body;
wherein the finger includes a second prong extending proximally from the main body, the first and second prongs being spaced apart from each other parallel to the second axis with a material void therebetween.
wherein the first and second prongs each define a notch; and
wherein the method includes guiding the rollable fiber in the notches.

28. A fiber management tray for managing optical fibers, the tray extending from a proximal end to a distal end along a first axis defining a length of the tray, from a first side to a second side along a second axis perpendicular to the first axis, the second axis defining a width of the tray, and from a top to a bottom along a third axis perpendicular to the first and second axes, the third axis defining a height of the tray, the first and second axes defining a reference plane, the tray comprising:
a fiber management surface lying parallel to the reference plane;
one or more hinge components defining a pivot axis that is parallel the second axis;
walls extending from the fiber management surface parallel to the third axis, the walls and fiber management surface defining a channel, the channel including a channel entryway through which optical fibers exterior to the tray can enter the tray, the channel entryway being defined by the walls and a portion of the fiber management surface connecting the walls; and
a finger projecting proximally from an exterior side of one of the walls to a free, proximal end of the finger, the finger extending proximally beyond a distal end of the channel entryway, the finger including a main body and a first prong extending proximally from the main body, wherein the finger including a second prong extending proximally from the main body, the first and second prongs being spaced apart from each other parallel to the second axis with a material void therebetween, the first and second prongs each defining a notch.

29. A method of routing a length of rollable optical fiber ribbon on the tray according to any of claims 1-20, the length extending along a longitudinal axis of the rollable optical fiber ribbon from the channel entryway to an end of the rollable optical fiber ribbon, the method comprising:
looping the length of the rollable optical fiber ribbon on the fiber management surface into fewer than three full loops; and
splicing the end of the rollable optical fiber ribbon to at least one other optical fiber at a splice body supported by the tray,
wherein the length is at least 60 centimeters.

30. The method of claim 29, wherein the length is at least 70 centimeters and less than 130 centimeters.

31. The method of claim 29, wherein the length is about 120 centimeters.

32. The method of claim 29, wherein the length is at least 70 centimeters and less than 90 centimeters.

33. The method of claim 29, wherein the length is about 80 centimeters.

34. The method of any of claims 29-33, wherein the at least one other optical fiber is a rollable fiber ribbon.

35. The method of any of claims 29-33, wherein the at least one other optical fiber is a flat fiber ribbon.

36. The method of any of claims 29-35, further comprising:
looping a length of the at least one other optical fiber on the fiber management surface into fewer than three full loops, the length of the at least one other optical fiber extending along a longitudinal axis of the at least one other optical fiber from another channel entry of the tray to an end of the at least one other optical fiber that is spliced to the end of the optical fiber ribbon, the length of the at least one other optical fiber being at least 60 centimeters.

37. The method of claim 36, wherein the fewer than three full loops of the rollable optical fiber ribbon are routed on the fiber management surface in one of a clockwise or counterclockwise manner, and the fewer than the three full loops of the at least one other optical fiber are routed on the fiber management surface in the other of a clockwise or counterclockwise manner.

38. The method of any of claims 29-37, wherein the at least one other optical fiber is a plurality of loose optical fibers.
